(19) United States
(12) Patent Application Publication
(10) Pub. No.: US 2016/0074775 A1
(43) Pub. Date: Mar. 17, 2016

(54) CONTINUOUS CHROMATOGRAPHY METHOD AND SYSTEM

(71) Applicant: Pall Corporation, Port Washington, NY (US)

(72) Inventors: Aleksandar CVETKOVIC, Marlborough, MA (US); Richard A. MARTINO, Brighton, MA (US); Karl K. ROGLER, Lincoln, MA (US)

(21) Appl. No.: 14/483,972

(22) Filed: Sep. 11, 2014

(51) Int. Cl. B01D 15/38; B01D 15/12; B01D 15/18

(52) U.S. Cl. CPC B01D 15/3809; B01D 15/1871; B01D 15/125

(57) ABSTRACT

Continuous chromatography methods and systems are disclosed, wherein a tangential flow filtration device used in association with at least a first chromatography device and a second chromatography device, concentrate a product of interest, which improves sorbent utilization.

### BACKGROUND OF THE INVENTION

Chromatography sorbents can be used to purify proteins and polypeptides. For example, chromatography columns containing sorbents can be used in batch mode, wherein the columns are partially loaded due to kinetic limitations of protein/polypeptide adsorption. In some industries, for example, the petrochemical industry, continuous or simulated moving bed chromatography is used to purify a compound of interest, wherein several interconnected columns are simultaneously operated, and the breakthrough of the compound of interest from a loading column is directed to the next column.

However, there is a need for improved chromatograph methods and systems. The present invention provides for ameliorating at least some of the disadvantages of the prior art. These and other advantages of the present invention will be apparent from the description as set forth below.

### BRIEF SUMMARY OF THE INVENTION

An embodiment of the invention provides a continuous chromatography system comprising (a) a first chromatography device for capturing at least one desired component, the first chromatography device comprising a housing having an inlet and an outlet and providing a fluid flow path between the inlet and the outlet; and a first chromatography medium disposed in the housing across the fluid flow path; (b) a tangential flow filtration device, comprising a housing comprising an inlet, a first outlet, and a second outlet, defining a first fluid flow path between the inlet and the first outlet, and a second fluid flow path between the inlet and the second outlet, and a porous filter element comprising at least one porous membrane across the first fluid flow path, wherein the second outlet of the tangential flow filtration device is in fluid communication with the inlet of the first chromatography device, and with an inlet of a second chromatography device for capturing the at least one desired component; (c) a first effluent fluid flow path in fluid communication with the outlet of the first chromatography device, the first effluent fluid flow path comprising at least a first conduit; (d) (di) a first sensor associated with the first effluent fluid flow path, wherein the sensor detects the presence or absence of the desired component passing from the outlet of the first chromatography device along the first effluent fluid flow path, and provides a signal indicating of the presence or absence of the desired component, or (dii) a time control arrangement, providing a signal indicating a set period of time with respect to operation of the first chromatography device has elapsed; (e) a first downstream controllable flow control arrangement comprising a first valve, downstream of the outlet of the first chromatography device, and downstream of the first sensor if present, the first downstream controllable flow control arrangement being in fluid communication with the first effluent fluid flow path, wherein, (ei) after the signal indicating of the presence or absence of the desired component is provided, or (eii) after the signal indicating the set period of time has elapsed is provided; the first downstream controllable flow control arrangement allows and/or prevents fluid flow along a first eluted component fluid flow path, a first waste fluid flow path, and a first desired component recycle fluid flow path; wherein the first eluted component fluid flow path, the first waste fluid flow path, and the first desired component recycle fluid flow path are downstream of, and in fluid communication with, the first downstream controllable flow control arrangement; (f) the first eluted component fluid flow path comprising at least a second conduit; (g) an eluted component container, downstream of, and in fluid communication with, the first eluted component fluid flow path, and with a second eluted component fluid flow path; (h) the first waste fluid flow path comprising at least a third conduit; (i) a waste container, downstream of, and in fluid communication with, the first waste fluid flow path and with a second waste fluid flow path; (j) the first desired component recycle fluid flow path comprising at least a fourth conduit; (k) a mixing container, suitable for receiving continuous feed and desired component recycle fluid comprising a desired component to be purified, in fluid communication with the first desired component recycle fluid flow path, and with the inlet of the tangential flow filtration device, and with a second desired component recycle fluid flow path; (l) the second chromatography device for capturing the at least one desired component, the second chromatography device comprising a housing having the inlet and an outlet and providing a fluid flow path between the inlet and the outlet; and a second chromatography medium disposed in the housing across the fluid flow path; (m) a second effluent fluid flow path in fluid communication with the outlet of the second chromatography device, the second effluent fluid flow path comprising at least a fifth conduit; (n) (ni) a second sensor associated with the second effluent fluid flow path, wherein the sensor detects the presence or absence of the desired component passing from the outlet of the second chromatography device along the second effluent fluid flow path, and provides a signal indicating of the presence or absence of the desired component, or (nii) a time control arrangement, providing a signal indicating a set period of time with respect to operation of the second chromatography device has elapsed; (o) a second downstream controllable flow control arrangement comprising a second valve, downstream of the outlet of the second chromatography device, and downstream of the second sensor if present, the second downstream controllable flow control arrangement being in fluid communication with the second effluent fluid flow path, wherein, (oi) after the signal indicating of the presence or absence of the desired component is provided, or (oii) after the signal indicating the set period of time has elapsed is provided; the second downstream controllable flow arrangement allows and/or prevents fluid flow along the second eluted component fluid flow path, the second waste fluid flow path, and the second desired component recycle fluid flow path; wherein the second eluted component fluid flow path, the second waste fluid flow path, and the second desired component recycle fluid flow path are downstream of, and in fluid communication with, the second downstream controllable flow arrangement; (p) the second eluted component fluid flow path comprising at least a sixth conduit, wherein the eluted component container of (g) is downstream of, and in fluid communication with, both the second eluted component fluid flow path and the first eluted component fluid flow path; (q) the second waste fluid flow path comprising at least a seventh conduit, wherein the waste container of (i) is downstream of, and in fluid communication with, both the second waste fluid flow path and the first waste fluid flow path; and, (r) the second desired component recycle fluid flow path comprising at least an eighth conduit, wherein the mixing container of (k) is in fluid communication with the first desired component recycle fluid flow path, and the second desired component recycle fluid flow path, and the inlet of the tangential flow filtration device.

In another embodiment, a chromatography system is provided, comprising (a) a first chromatography device for capturing at least one desired component, the first chromatography device comprising a housing having an inlet and an outlet and providing a fluid flow path between the inlet and the outlet; and a first chromatography medium disposed in the housing across the fluid flow path; (b) a first effluent fluid flow path in fluid communication with the outlet of the first chromatography device, the first effluent fluid flow path comprising at least a first conduit; (c) (ci) a first sensor associated with the first effluent fluid flow path, wherein the first sensor detects the presence or absence of the desired component passing from the outlet of the first chromatography device along the first effluent fluid flow path, and provides a signal indicating of the presence or absence of the desired component, or (cii) a time control arrangement, providing a signal indicating a set period of time with respect to operation of the first chromatography device has elapsed; (d) a first downstream controllable flow control arrangement comprising a first valve, downstream of the outlet of the first chromatography device, and downstream of the first sensor if present, the first downstream controllable flow control arrangement being in fluid communication with the first effluent fluid flow path, wherein, after the signal indicative of the presence or absence of the desired component is provided, the first downstream controllable flow arrangement allows and/or prevents fluid flow along a first eluted component fluid flow path, a first waste fluid flow path, and a first desired component fluid flow path; wherein the first eluted component fluid flow path, the first waste fluid flow path, and the first desired component fluid flow path are downstream of, and in fluid communication with, the first downstream controllable flow arrangement; (e) the first eluted component fluid flow path comprising at least a second conduit; (f) eluted component container, downstream of, and in fluid communication with, the first eluted component fluid flow path and a second eluted component fluid flow path; (g) the first waste fluid flow path comprising at least a third conduit; (h) a waste container, downstream of and in fluid communication with, the first waste fluid flow path and a second waste fluid flow path; (i) the first desired component fluid flow path comprising at least a fourth conduit; (j) a tangential flow filtration device, comprising a housing comprising an inlet, a first outlet, and a second outlet, defining a first fluid flow path between the inlet and the first outlet, and a second fluid flow path between the inlet and the second outlet, and a porous filter element comprising at least one porous membrane across the first fluid flow path, wherein the inlet of the tangential flow filtration device is in fluid communication with the first desired component fluid flow path and with a second desired component fluid flow path, and the second outlet is in fluid communication with a desired component recycle fluid flow path; and, (k) a mixing container, suitable for receiving desired component recycle fluid comprising a desired component to be purified, in fluid communication with the second outlet of the tangential flow filtration device, wherein the mixing container is also in fluid communication with the inlet of the first chromatography device, and with an inlet of a second chromatography device, and wherein the mixing container is also suitable for receiving continuous feed comprising the desired component to be purified; (l) the second chromatography device for capturing the at least one desired component, the second chromatography device comprising a housing having the inlet and an outlet and providing a fluid flow path between the inlet and the outlet; and a second chromtography medium disposed in the housing across the fluid flow path; (m) a second effluent fluid flow path in fluid communication with the outlet of the second chromatography device, the second effluent fluid flow path comprising at least a fifth conduit; (n) (ni) a second sensor associated with the second effluent fluid flow path, wherein the sensor detects the presence or absence of the desired component passing from the outlet of the second chromatography device along the second effluent fluid flow path, and provides a signal indicating of the presence or absence of the desired component, or (nii) a time control arrangement, providing a signal indicating a set period of time with respect to operation of the second chromatography device has elapsed; (o) a second downstream controllable flow control arrangement comprising a second valve, downstream of the outlet of the second chromatography device, and downstream of the second sensor if present, the second downstream controllable flow control arrangement being in fluid communication with the second effluent fluid flow path, wherein, (oi) after the signal indicating of the presence or absence of the desired component is provided, or (oii) after the signal indicating the set period of time has elapsed is provided; the second flow control arrangement allows and/or prevents fluid flow along the second eluted component fluid flow path, the second waste fluid flow path, and the second desired component fluid flow path; wherein the second eluted component fluid flow path, the second waste fluid flow path, and the second desired component fluid flow path are downstream of, and in fluid communication with, the second flow control arrangement; (p) the second eluted component fluid flow path comprising at least a sixth conduit, wherein the eluted component container of (g) is downstream of, and in fluid communication with, both the second eluted component fluid flow path and the first eluted component fluid flow path; (q) the second waste fluid flow path comprising at least a seventh conduit, wherein the waste container of (h) is downstream of, and in fluid communication with, both the second waste fluid flow path and the first waste fluid flow path; and, (r) the second desired component fluid flow path comprising at least an eighth conduit, wherein the inlet of the tangential flow filtration device of (j) is in fluid communication with the first desired component fluid flow path, and the second desired component fluid flow path.

in another embodiment, a chromatographic method for obtaining at least one desired component is provided, the method comprising (a) passing a fluid comprising at least one desired component from a mixing container and into a tangential flow filtration device, the tangential flow filtration device comprising a housing comprising an inlet, a first outlet, and a second outlet, defining a first fluid flow path between the inlet and the first outlet, and a second fluid flow path between the inlet and the second outlet, and a porous filter element having an upstream surface and a downstream surface and comprising a porous membrane across the first fluid flow path, wherein the second outlet of the tangential flow filtration device is in fluid communication with an inlet of a first chromatography device; passing the fluid comprising at least one desired component tangentially to the upstream surface of the filter element; passing a desired component concentrated fluid tangentially to the upstream surface and along the second fluid flow path and through the second outlet into the inlet of the chromatography device; and passing a desired component reduced fluid along the first fluid flow path through the filter element and through the first outlet along a third waste fluid flow path to a waste container; (b) passing the desired component concentrated fluid into the first chromatography device, the first chromatography device comprising a housing having the inlet and an outlet and providing a fluid flow path between the inlet and the outlet; and a first chromatography medium for binding the at least one desired component, disposed in the housing across the fluid flow path; (c) passing fluid from the outlet of the first chromatography device along a first effluent fluid flow path, including (ci) detecting the presence or absence of the desired component(s) in the fluid, or (cii) determining whether one or more set periods of time have elapsed, the set periods of time comprising a first waste fluid flow time, a first desired component recycle fluid flow time, and a first eluted component fluid flow path time; (d) opening and/or closing one or more of the following flow paths: a first desired component recycle fluid flow path, a first waste fluid flow path, and a first eluted component fluid flow path, wherein, (di) if the desired component(s) is not detected, or detected at less than a pre-set value, or (dii) if the first desired component recycle fluid flow time has not elapsed, the first desired component recycle fluid flow path is opened, and the first waste fluid flow path and the first eluted component fluid flow path are closed; and, (diii) if the desired component(s) is detected at equal to, or greater than, the pre-set value, or (div) if the first desired component recycle fluid flow time has not elapsed, the first desired component recycle fluid flow path is opened or remains open, and the first waste fluid flow path and the first eluted component fluid flow path are closed or remain closed; and, (dv) if after the desired component(s) have previously been detected at equal to, or greater than, the pre-set value, and the desired component(s) is subsequently not detected, or detected at less than the pre-set value, or (dvi) if the first desired component recycle fluid flow time has elapsed, the first desired component recycle fluid flow path and the first eluted component fluid flow path are closed, and the first waste fluid flow path is opened; (e) passing fluid along the opened fluid flow path, wherein, if the first waste fluid flow path is opened, the method includes passing fluid along the first waste fluid flow path into a waste container, and if the first desired component recycle fluid flow path is opened, the method includes passing fluid along the first desired component recycle fluid flow path into the mixing container, and passing fluid from the mixing container into the inlet of the tangential fluid flow filter device; (f) passing the desired component concentrated fluid from the second outlet of the tangential flow filtration device into a second chromatography device, the second chromatography device comprising a housing having the inlet and an outlet and providing a fluid flow path between the inlet and the outlet; and a second chromatography medium for binding the at least one desired component, disposed in the housing across the fluid flow path; (g) passing fluid from the outlet of the second chromatography device along a second effluent fluid flow path, including (gi) detecting the presence or absence of the desired component(s) in the fluid, or (gii) determining whether one or more set periods of time have elapsed, the set periods of time comprising a second waste fluid flow time, a second desired component recycle fluid flow time, and a second eluted component fluid flow path time; (h) opening and/or closing one or more of the following flow paths: a second desired component recycle fluid flow path, a second waste fluid flow path, and a second eluted component fluid flow path, wherein, (hi) if the desired component(s) is not detected, or detected at less than a pre-set value, or (hii) if the second desired component recycle fluid flow time has not elapsed, the second desired component recycle fluid flow path is opened, and the second waste fluid flow path and the second eluted component fluid flow path are closed; and, (hiii) if the desired component(s) is detected at equal to, or greater than, the pre-set value, or (hiv) if the second desired component recycle fluid flow time has not elapsed, the second desired component recycle fluid flow path is opened or remains open, and the second waste fluid flow path and the second eluted component fluid flow path are closed or remain closed; and, (hv) if after the desired component(s) have previously been detected at equal to, or greater than, the pre-se(value, and the desired component(s) is subsequently not detected, or detected at less than the pre-set value, or (hvi) if the second desired component recycle fluid flow time has elapsed, the second desired component recycle fluid flow path and the second dined component fluid flow path are closed, and the second waste fluid flow path is opened; (i) passing fluid along the opened fluid flow path, wherein, if the second waste fluid flow path is opened, the method includes passing fluid along the second waste fluid flow path into the waste container, and if the second desired component recycle fluid flow path is opened, the method includes passing fluid along the second desired component recycle fluid flow path into the mixing container, and passing fluid from the mixing container into the tangential fluid flow filter device; and (j) repealing (a)-(i) at least once.

In yet another embodiment, a chromatographic method for obtaining at least one desired component is provided, the method comprising (a) passing a fluid comprising at least one desired component from a mixing container and into an inlet of a first chromatography device, and through the first chromatography device, the device comprising a housing having the inlet and an outlet and providing a fluid flow path between the inlet and the outlet; and a first chromatography medium for binding the at least one desired component, disposed in the housing across the fluid flow path; (b) passing fluid from the outlet of the first chromatography device along a first effluent fluid flow path, including (bi) detecting the presence or absence of the desired component(s) in the fluid, or (bii) determining whether one or more set periods of time have elapsed, the set periods of time comprising a first waste fluid flow time, a first desired component fluid flow time, and a first eluted component fluid flow path time; (c) opening and/or closing one or more of the following flow paths: a first desired component fluid flow path, a first waste fluid flow path, and a first eluted component fluid flow path, wherein, (ci) if the desired component(s) is not detected, or detected at less than a pre-set value, or (cii) if the desired component fluid flow time has not elapsed, the first desired component fluid flow path is opened, and the first waste fluid flow path and the first eluted component fluid flow path are closed; and, (ciii) if the desired component(s) is detected at equal to, or greater than, the pre-set value, or (civ) if the first desired component fluid flow time has not elapsed, the first desired component fluid flow path is opened or remains open, and the first waste fluid flow path and the first eluted component fluid flow path are closed or remain closed; and, (cv) if after the desired component(s) have previously been detected at equal to, or greater than, the pre-set value, and the desired component(s) is subsequently not detected, or detected at less than the pre-set value, or (cvi) if the first desired component fluid flow time has elapsed, the first desired component fluid flow path and the first eluted component fluid flow path are closed, and the first waste fluid flow path is opened; (d) passing fluid along the opened fluid flow path, wherein, if the first waste fluid flow path is opened, the method includes passing fluid along the first waste fluid flow path into a waste container, and if the first desired component fluid flow path is opened, the method includes passing fluid along the first desired component fluid flow path into an inlet of a tangential fluid flow filter device, the tangential flow filtration device comprising a housing comprising the inlet, a first outlet, and a second outlet, defining a first fluid flow path between the inlet and the first outlet, and a second fluid flow path between the inlet and the second outlet, and a porous filter element having an upstream surface and a downstream surface and comprising a porous membrane across the first fluid flow path, wherein the second outlet of the tangential flow filtration device is in fluid communication with the mixing container via a desired component recycle fluid flow path, wherein the mixing container is also in fluid communication with both the second outlet of the tangential flow filtration device and the inlet of the first chromatography device, and wherein the mixing container also receives fluid along a continuous feed; (e) passing the fluid comprising at least one desired component tangentially to the upstream surface of the filter element; passing a desired component concentrated fluid tangentially to the upstream surface and along the second fluid flow path and through the second outlet along the desired component recycle fluid path into the mixing container; and passing a desired component reduced fluid along the first fluid flow path through the filter element and through the first outlet along a third waste fluid flow path to a waste container; (f) passing fluid from the mixing container into a second chromatography device, the second chromatography device comprising a housing having the inlet and an outlet and providing a fluid flow path between the inlet and the outlet; and a second chromatography medium for binding the at least one desired component, disposed in the housing across the fluid flow path; (g) passing fluid from the outlet of the second chromatography device along a second effluent fluid flow path, including (gi) detecting the presence or absence of the desired component(s) in the fluid, or (gii) determining whether one or more set periods of time have elapsed, the set periods of time comprising a second waste fluid flow time, a second desired component fluid flow time, and a second eluted component fluid flow path time; (h) opening and/or closing one or more of the following flow paths: a second desired component fluid flow path, a second waste fluid flow path, and a second eluted component fluid flow path, wherein, (hi) if the desired component(s) is not detected, or detected at less than a pre-set value, or (hii) if the second desired component fluid flow time has not elapsed, the second desired component fluid flow path is opened, and the second waste fluid flow path and the second eluted component fluid flow path are closed; and, (hiii) if the desired component(s) is detected at equal to, or greater than, the pre-set value, or (hiv) if the second desired component fluid flow time has not elapsed, the second desired component fluid flow path is opened or remains open, and the second waste fluid flow path and the second eluted component fluid flow path are closed or remain closed; and, (hv) if after the desired component(s) have previously been detected at equal to, or greater than, the pre-set value, and the desired component(s) is subsequently not detected, or detected at less than the pre-set value, or (hvi) if the second desired component fluid flow time has elapsed, the second desired component fluid flow path and the second eluted component fluid flow path are closed, and the second waste fluid flow path is opened; passing fluid along the opened fluid flow path, wherein, if the second waste fluid flow path is opened, the method includes passing fluid along the second waste fluid flow path into the waste container, and if the second desired component fluid flow path is opened, the method includes passing fluid along the second desired component fluid flow path into the inlet of the tangential fluid flow filter device; and (j) repeating (a)-(i) at least once.

### BRIEF DESCRIPTION OF THE SEVERAL VIEWS OF THE DRAWING(S)

FIG. 1 shows, diagrammatically, an embodiment of a chromatography system including first and second chromatography devices according to the present invention, showing a tangential flow filtration (TFF) device arranged in a fluid flow path between a mixing tank (the mixing tank receiving continuous feed), and the chromatography devices, wherein the TFF device is upstream of the first chromatography device and the second chromatography device, and first and second product detectors (sensors) are associated with first and second effluent fluid flow paths downstream of the first and second chromatography devices, respectively. FIG. 1 also shows an optional surge tank, downstream of the TFF device, and upstream of the chromatography devices.

FIG. 2 shows, diagrammatically, another embodiment of a chromatography system including first and second chromatography devices according to the present invention, showing the first and second chromatography devices receiving fluid flow from a mixing tank (the mixing tank receiving continuous feed), wherein a TFF device is arranged in a fluid flow path downstream of the first chromatography device and the second chromatography device (and downstream of effluent fluid flow paths from the first and second chromatography devices), and first and second product detectors (sensors) are associated with first and second effluent fluid flow paths downstream of the first and second chromatography devices, respectively. FIG. 2 also shows an optional surge tank, upstream of the TFF device, and downstream of the chromatography devices.

FIG. 3 shows, diagrammatically, another embodiment of a chromatography system including first and second chromatography devices according to the present invention, showing a TFF device arranged in a fluid flow path between a mixing tank (the mixing tank receiving continuous feed), and the chromatography devices, wherein the TFF device is upstream of the first chromatography device and the second chromatography device, and the system also includes a time control arrangement. For ease of understanding FIG. 3 shows subsets of the time control arrangement associated with the first and second chromatography devices (via upstream and downstream flow control arrangements communicating with the chromatography devices) respectively, though software can be used for the time control. FIG. 3 also shows an optional surge tank, downstream of the TFF device, and upstream of the chromatography devices.

FIG. 4 shows, diagrammatically, another embodiment of a chromatography system including first and second chromatography devices according to the present invention, showing the first and second chromatography devices receiving fluid flow from a mixing tank (the mixing tank receiving continuous feed), wherein a TFF device is arranged in a fluid flow path downstream of the first chromatography device and the second chromatography device (and downstream of effluent fluid flow paths from the first and second chromatography devices), and the system also includes a time control arrangement. For ease of understanding, FIG. 4 shows subsets of the time control arrangement associated with the first and second chromatography devices (via upstream and downstream flow control arrangements communicating with the chromatography devices) respectively, though software can be used for the time control. FIG. 4 also shows an optional surge tank, upstream of the tangential fluid flow filtration device, and downstream of the chromatography devices.

### DETAILED DESCRIPTION OF THE INVENTION

Tangential fluid flow filter devices are used to improve the concentration and/or purification of one or more desired components in a fluid, and in accordance with an embodiment of the present invention, usability of the sorbent in chromatography devices are improved when the tangential fluid flow filter devices are used with: first and second chromatography devices; first and second sensors associated with the effluent fluid flow paths of the respective chromatography devices, the sensors detecting the presence or absence of at least one desired component passing from the outlets of the chromatography devices, and producing signals indicative of the presence of absence of the desired component(s); or (ii) a time control arrangement, providing signals indicating set periods of time has elapsed with respect to the operation of the first and second chromatography devices; and first and second downstream controllable flow control arrangements, each comprising a valve, downstream of the outlets of the respective chromatography devices, and downstream of the respective sensors if present, the controllable flow control arrangements being in fluid communication with the respective effluent fluid flow paths, wherein, (i) after the signals indicative of the presence or absence of the desired component(s) is/are produced, or (ii) after the signals indicating the set periods of time have elapsed are provided; the downstream flow control arrangements allow and/or prevent fluid flow along respective eluted component fluid flow paths, waste fluid flow paths, desired component fluid flow paths; and desired component recycle fluid flow paths; wherein the eluted component fluid flow paths, the waste fluid flow paths, desired component fluid flow paths, and the desired component recycle fluid flow paths are downstream of and in fluid communication with, the flow control arrangements. Preferably, embodiments of the invention further comprise first and second upstream controllable flow control arrangements, each comprising a valve, upstream of the inlets of the respective chromatography devices, in fluid communication with a mixing container and/or the second outlet of a TFF device, each preferably also in fluid communication with at least one additional container, such as at least one, typically two or more, buffer containers in accordance with embodiments of the invention, the tangential fluid flow filter devices can be arranged, for example, after the chromatography devices and before a mixing container and/or between the mixing container and the chromatography devices.

Embodiments of the invention encompass more than two chromatography devices, e.g., three or more, four or more, or any number of chromatography devices.

Advantageously, in contrast with conventional systems, wherein media in chromatography devices used in batch mode are only partially loaded due to kinetic limitations of protein adsorption (dynamic binding capacities (DBCs)) are commonly between about 30-50% of their static binding capacities), media can be used more efficient in accordance with the invention. Other advantages include an increase in specific productivity and improved process economics (e.g., reduced resin volume, reduced buffer and water usage, and faster processing).

In another advantage is that, in accordance with embodiments of the invention, if desired, a combination of loading and non-loading can occur with different chromatography devices during a given chromatography cycle.

An embodiment of the invention provides a continuous chromatography system comprising (a) a first chromatography device for capturing at least one desired component, the first chromatography device comprising a housing having an inlet and an outlet and providing a fluid flow path between the inlet and the outlet; and a first chromatography medium disposed in the housing across the fluid flow path; (b) a tangential flow filtration device, comprising a housing comprising an inlet, a first outlet, and a second outlet, defining a first fluid flow path between the inlet and the first outlet, and a second fluid flow path between the inlet and the second outlet, and a porous filter element comprising at least one porous membrane across the first fluid flow path, wherein the second outlet of the tangential flow filtration device is in fluid communication with the inlet of the first chromatography device, and with an inlet of a second chromatography device for capturing the at least one desired component; (c) a first effluent fluid flow path in fluid communication with the outlet of the first chromatography device, the first effluent fluid flow path comprising at least a first conduit; (d) (di) a first sensor associated with the first effluent fluid flow path, wherein the sensor detects the presence or absence of the desired component passing from the outlet of the first chromatography device along the first effluent fluid flow path, and provides a signal indicating of the presence or absence of the desired component, or (dii) a time control arrangement, providing a signal indicating a set period of time with respect to operation of the first chromatography device has elapsed; (e) a first downstream controllable flow control arrangement comprising a first valve, downstream of the outlet of the first chromatography device, and downstream of the first sensor if present, the first downstream controllable flow control arrangement being in fluid communication with the first effluent fluid flow path, wherein, (ei) after the signal indicating of the presence or absence of the desired component is provided, or (eii) after the signal indicating the set period of time has elapsed is provided; the first downstream controllable flow control arrangement allows and/or prevents fluid flow along a first eluted component fluid flow path, a first waste fluid flow path, and a first desired component recycle fluid flow path; wherein the first eluted component fluid flow path, the first waste fluid flow path, and the first desired component recycle fluid flow path are downstream of, and in fluid communication with, the first downstream controllable flow control arrangement; (f) the first eluted component fluid flow path comprising at least a second conduit; (g) an eluted component container, downstream of, and in fluid communication with, the first eluted component fluid flow path, and with a second eluted component fluid flow path; (h) the first waste fluid flow path comprising at least a third conduit; (i) a waste container, downstream of, and in fluid communication with, the first waste fluid flow path and with a second waste fluid flow path; (j) the first desired component recycle fluid flow path comprising at least a fourth conduit; (k) a mixing container, suitable for receiving continuous feed and desired component recycle fluid comprising a desired component to be purified, in fluid communication with the first desired component recycle fluid flow path, and with the inlet of the tangential flow filtration device, and with a second desired component recycle fluid flow path; (l) the second chromatography device for capturing the at least one desired component, the second chromatography device comprising a housing having the inlet and an outlet and providing a fluid flow path between the inlet and the outlet; and a second chromatography medium disposed in the housing across the fluid flow path; (m) a second effluent fluid flow path in fluid communication with the outlet of the second chromatography device, the second effluent fluid flow path comprising at least a fifth conduit; (n) (ni) a second sensor associated with the second effluent fluid flow path, wherein the sensor detects the presence or absence of the desired component passing from the outlet of the second chromatography device along the second effluent fluid flow path, and provides a signal indicating of the presence or absence of the desired component, or (nii) a time control arrangement, providing a signal indicating a set period of time with respect to operation of the second chromatography device has elapsed; (o) a second downstream controllable flow control arrangement comprising a second valve, downstream of the outlet of the second chromatography device, and downstream of the second sensor if present, the second downstream controllable flow control arrangement being in fluid communication with the second effluent fluid flow path, wherein, (oi) after the signal indicating of the presence or absence of the desired component is provided, or (oii) after the signal indicating the set period of time has elapsed is provided; the second downstream controllable flow arrangement allows and/or prevents fluid flow along the second eluted component fluid flow path, the second waste fluid flow path, and the second desired component recycle fluid flow path; wherein the second eluted component fluid flow path, the second waste fluid flow path, and the second desired component recycle fluid flow path are downstream of, and in fluid communication with, the second downstream controllable flow arrangement; (p) the second eluted component fluid flow path comprising at least a sixth conduit, wherein the eluted component container of (g) is downstream of, and in fluid communication with, both the second eluted component fluid flow path and the first eluted component fluid flow path; (q) the second waste fluid flow path comprising at least a seventh conduit, wherein the waste container of (i) is downstream of, and in fluid communication with, both the second waste fluid flow path and the first waste fluid flow path; and, (r) the second desired component recycle fluid flow path comprising at least an eighth conduit, wherein the mixing container of (k) is in fluid communication with the first desired component recycle fluid flow path, and the second desired component recycle fluid flow path, and the inlet of the tangential flow filtration device.

In another embodiment, a chromatography system is provided, comprising (a) a first chromatography device for capturing at least one desired component, the first chromatography device comprising a housing having an inlet and an outlet and providing a fluid flow path between the inlet and the outlet; and a first chromatography medium disposed in the housing across the fluid flow path; (b) a first effluent fluid flow path in fluid communication with the outlet of the first chromatography device, the first effluent fluid flow path comprising at least a first conduit; (c) (ci) a first sensor associated with the first effluent fluid flow path, wherein the first sensor detects the presence or absence of the desired component passing from the outlet of the first chromatography device along the first effluent fluid flow path, and provides a signal indicating of the presence or absence of the desired component, or (cii) a time control arrangement, providing a signal indicating a set period of time with respect to operation of the first chromatography device has elapsed; (d) a first downstream controllable flow control arrangement comprising a first valve, downstream of the outlet of the first chromatography device, and downstream of the first sensor if present, the first downstream controllable flow control arrangement being in fluid communication with the first effluent fluid flow path, wherein, after the signal indicative of the presence or absence of the desired component is provided, the first downstream controllable flow arrangement allows and/or prevents fluid flow along a first eluted component fluid flow path, a first waste fluid flow path, and a first desired component fluid flow path; Wherein the first eluted component fluid flow path, the first waste fluid flow path, and the first desired component fluid flow path are downstream of, and in fluid communication with, the first downstream controllable flow arrangement; (e) the first eluted component fluid flow path comprising at least a second conduit; (f) eluted component container, downstream of, and in fluid communication with, the first eluted component fluid flow path and a second eluted component fluid flow path; (g) the first waste fluid flow path comprising at least a third conduit; (h) a waste container, downstream of, and in fluid communication with, the first waste fluid flow path and a second waste fluid flow path; (i) the first desired component fluid flow path comprising at least a fourth conduit; (j) a tangential flow filtration device, comprising a housing comprising an inlet, a first outlet, and a second outlet, defining a first fluid flow path between the inlet and the first outlet, and a second fluid flow path between the inlet and the second outlet, and a porous filter element comprising at least one porous membrane across the first fluid flow path, wherein the inlet of the tangential flow filtration device is in fluid communication with the first desired component fluid flow path and with a second desired component fluid flow path, and the second outlet is in fluid communication with a desired component recycle fluid flow path; and, (k) a mixing container, suitable for receiving desired component recycle fluid comprising a desired component to be purified, in fluid communication with the second outlet of the tangential flow filtration device, wherein the mixing container is also in fluid communication with the inlet of the first chromatography device, and with an inlet of a second chromatography device, and wherein the mixing container is also suitable for receiving continuous feed comprising the desired component to be purified; (l) the second chromatography device for capturing the at least one desired component, the second chromatography device comprising a housing having the inlet and an outlet and providing a fluid flow path between the inlet and the outlet; and a second chromatography medium disposed in the housing across the fluid flow path; (m) a second effluent fluid flow path in fluid communication with the outlet of the second chromatography device, the second effluent fluid flow path comprising at least a fifth conduit; (n) (ni) a second sensor associated with the second effluent fluid flow path, wherein the sensor detects the presence or absence of the desired component passing from the outlet of the second chromatography device along the second effluent fluid flow path, and provides a signal indicating of the presence or absence of the desired component, or (nii) a time control arrangement, providing a signal indicating a set period of time with respect to operation of the second chromatography device has elapsed; (o) a second downstream controllable flow control arrangement comprising a second valve, downstream of the outlet of the second chromatography device, and downstream of the second sensor if present, the second downstream controllable flow control arrangement being in fluid communication with the second effluent fluid flow path, wherein, (oi) after the signal indicating of the presence or absence of the desired component is provided, or (oii) after the signal indicating the set period of time has elapsed is provided; the second flow control arrangement allows and/or prevents fluid flow along the second eluted component fluid flow path, the second waste fluid flow path, and the second desired component fluid flow path; wherein the second eluted component fluid flow path, the second waste fluid flow path, and the second desired component fluid flow path are downstream of, and in fluid communication with, the second flow control arrangement; (p) the second eluted component fluid flow path comprising at least a sixth conduit, wherein the eluted component container of (g) is downstream of, and in fluid communication with, both the second eluted component fluid flow path and the first eluted component fluid flow path; (q) the second waste fluid flow path comprising at least a seventh conduit, wherein the waste container of (h) is downstream of, and in fluid communication with, both the second waste fluid flow path and the first waste fluid flow path; and, (r) the second desired component fluid flow path comprising at least an eighth conduit, wherein the inlet of the tangential flow filtration device of (j) is in fluid communication with the first desired component fluid flow path, and the second desired component fluid flow path.

Preferably, the system further comprises a first upstream controllable flow control arrangement comprising a third valve, upstream of, and in fluid communication with, the inlet of the first chromatography device, and a second upstream controllable flow control arrangement comprising a fourth valve, upstream of, and in fluid communication with, the inlet of the second chromatography device. In some embodiments, the upstream controllable flow control arrangements are in fluid communication with the second outlet of the tangential fluid filtration device, or in fluid communication with the mixing container. In the illustrated embodiments, each upstream controllable flow control arrangement is also in fluid communication with four additional containers, shown as buffer tanks.

In another embodiment, a chromatographic method for obtaining at least one desired component is provided, the method comprising (a) passing a fluid comprising at least one desired component from a mixing container and into a tangential flow filtration device, the tangential flow filtration device comprising a housing comprising an inlet, a first outlet, and a second outlet, defining a first fluid flow path between the inlet and the first outlet, and a second fluid flow path between the inlet and the second outlet, and a porous filter element having an upstream surface and a downstream surface and comprising a porous membrane across the first fluid flow path, wherein the second outlet of the tangential flow filtration device is in fluid communication with an inlet of a first chromatography device; passing the fluid comprising at least one desired component tangentially to the upstream surface of the filter element; passing a desired component concentrated fluid tangentially to the upstream surface and along the second fluid flow path and through the second outlet into the inlet of the chromatography device; and passing a desired component reduced fluid along the first fluid flow path through the filter element and through the first outlet along a third waste fluid flow path to a waste container; (b) passing the desired component concentrated fluid into the first chromatography device, the first chromatography device comprising a housing having the inlet and an outlet and providing a fluid flow path between the inlet and the outlet; and a first chromatography medium for binding the at least one desired component, disposed in the housing across the fluid flow path; (c) passing fluid from the outlet of the first chromatography device along a first effluent fluid flow path, including (ci) detecting the presence or absence of the desired component(s) in the fluid, or (cii) determining whether one or more set periods of time have elapsed, the set periods of time comprising a first waste fluid flow time, a first desired component recycle fluid flow time, and a first eluted component fluid flow path time; (d) opening and/or closing one or more of the following flow paths: a first desired component recycle fluid flow path, a first waste fluid flow path, and a first eluted component fluid flow path, wherein, (di) if the desired component(s) is not detected, or detected at less than a pre-set value, or (dii) if the first desired component recycle fluid flow time has not elapsed, the first desired component recycle fluid flow path is opened, and the first waste fluid flow path and the first eluted component fluid flow path are closed; and, (diii) if the desired component(s) is detected at equal to, or greater than, the pre-set value, or (div) if the first desired component recycle fluid flow time has not elapsed, the first desired component recycle fluid flow path is opened or remains open, and the first waste fluid flow path and the first eluted component fluid flow path are closed or remain closed; and, (dv) if after the desired component(s) have previously been detected at equal to, or greater than, the pre-set value, and the desired component(s) is subsequently not detected, or detected at less than the pre-set value, or (dvi) if the first desired component recycle fluid flow time has elapsed, the first desired component recycle fluid flow path and the first eluted component fluid flow path are closed, and the first waste fluid flow path is opened; (e) passing fluid along the opened fluid flow path, wherein, if the first waste fluid flow path is opened, the method includes passing fluid along the first waste fluid flow path into a waste container, and if the first desired component recycle fluid flow path is opened, the method includes passing fluid along the first desired component recycle fluid flow path into the mixing container, and passing fluid from the mixing container into the inlet of the tangential fluid flow filter device; (f) passing the desired component concentrated fluid from the second outlet of the tangential flow filtration device into a second chromatography device, the second chromatography device comprising a housing having the inlet and an outlet and providing a fluid flow path between the inlet and the outlet; and a second chromatography medium for binding the at least one desired component, disposed in the housing across the fluid flow path; (g) passing fluid from the outlet of the second chromatography device along a second effluent fluid flow path, including (gi) detecting the presence or absence of the desired component(s) in the fluid, or (gii) determining whether one or more set periods of time have elapsed, the set periods of time comprising a second waste fluid flow time, a second desired component recycle fluid flow time, and a second eluted component fluid flow path time; (h) opening and/or closing one or more of the following flow paths: a second desired component recycle fluid flow path, a second waste fluid flow path, and a second dined component fluid flow path, wherein, (hi) if the desired component(s) is not detected, or detected at less than a pre-set value, or (hii) if the second desired component recycle fluid flow time has not elapsed, the second desired component recycle fluid flow path is opened, and the second waste fluid flow path and the second doted component fluid flow path are closed; and, (hiii) if the desired component(s) is detected at equal to, or greater than, the pre-set value, or (hiv) if the second desired component recycle fluid flow time has not elapsed, the second desired component recycle fluid flow path is opened or remains open, and the second waste fluid flow path and the second dined component fluid flow path are closed or remain closed; and, (hv) if after the desired component(s) have previously been detected at equal to, or greater than, the pre-set value, and the desired component(s) is subsequently not detected, or detected at less than the pre-set value, or (hvi) if the second desired component recycle fluid flow time has elapsed, the second desired component recycle fluid flow path and the second eluted component fluid flow path are closed, and the second waste fluid flow path is opened; (i) passing fluid along the opened fluid flow path, wherein, if the second waste fluid flow path is opened, the method includes passing fluid along the second waste fluid flow path into the waste container, and if the second desired component recycle fluid flow path is opened, the method includes passing fluid along the second desired component recycle fluid flow path into the mixing container, and passing fluid from the mixing container into the tangential fluid flow filter device; and (j) repeating (a)-(i) at least once.

In yet another embodiment, a chromatographic method for obtaining at least one desired component is provided, the method comprising (a) passing a fluid comprising at least one desired component from a mixing container and into an inlet of a first chromatography device, and through the first chromatography device, the device comprising a housing having the inlet and an outlet and providing a fluid flow path between the inlet and the outlet; and a first chromatography medium for binding the at least one desired component, disposed in the housing across the fluid flow path; (b) passing fluid from the outlet of the first chromatography device along a first effluent fluid flow path, including (bi) detecting the presence or absence of the desired component(s) in the fluid, or (bii) determining whether one or more set periods of time have elapsed, the set periods of time comprising a first waste fluid flow time, a first desired component fluid flow time, and a first eluted component fluid flow path time; (c) opening and/or closing one or more of the following flow paths: a first desired component fluid flow path, a first waste fluid flow path, and a first eluted component fluid flow path, wherein, (ci) if the desired component(s) is not detected, or detected at less than a pre-set value, or (cii) if the desired component fluid flow time has not elapsed, the first desired component fluid flow path is opened, and the first waste fluid flow path and the first eluted component fluid flow path are closed; and, (ciii) if the desired component(s) is detected at equal to, or greater than, the pre-set value, or (civ) if the first desired component fluid flow time has not elapsed, the first desired component fluid flow path is opened or remains open, and the first waste fluid flow path and the first eluted component fluid flow path are closed or remain closed; and, (cv) if after the desired component(s) have previously been detected at equal to, or greater than, the pre-set value, and the desired component(s) is subsequently not detected, or detected at less than the pre-set value, or (cvi) if the first desired component fluid flow time has elapsed, the first desired component fluid flow path and the first eluted component fluid flow path are closed, and the first waste fluid flow path is opened; (d) passing fluid along the opened fluid flow path, wherein, if the first waste fluid flow path is opened, the method includes passing fluid along the first waste fluid flow path into a waste container, and if the first desired component fluid flow path is opened, the method includes passing fluid along the first desired component fluid flow path into an inlet of a tangential fluid flow filter device, the tangential flow filtration device comprising a housing comprising the inlet, a first outlet, and a second outlet, defining a first fluid flow path between the inlet and the first outlet, and a second fluid flow path between the inlet and the second outlet, and a porous filter element having an upstream surface and a downstream surface and comprising a porous membrane across the first fluid flow path, wherein the second outlet of the tangential flow filtration device is in fluid communication with the mixing container via a desired component recycle fluid flow path, wherein the mixing container is also in fluid communication with both the second outlet of the tangential flow filtration device and the inlet of the first chromatography device, and wherein the mixing container also receives fluid along a continuous feed; (e) passing the fluid comprising at least one desired component tangentially to the upstream surface of the filter element; passing a desired component concentrated fluid tangentially to the upstream surface and along the second fluid flow path and through the second outlet along the desired component recycle fluid path into the mixing container; and passing a desired component reduced fluid along the first fluid flow path through the filter element and through the first outlet along a third waste fluid flow path to a waste container; (f) passing fluid from the mixing container into a second chromatography device, the second chromatography device comprising a housing having the inlet and an outlet and providing a fluid flow path between the inlet and the outlet; and a second chromatography medium for binding the at least one desired component, disposed in the housing across the fluid flow path; (g) passing fluid from the outlet of the second chromatography device along a second effluent fluid flow path, including (gi) detecting the presence or absence of the desired component(s) in the fluid, (gii) determining whether one or more set periods of time have elapsed, the set periods of time comprising a second waste fluid flow time, a second desired component fluid flow time, and a second dined component fluid flow path time; (h) opening and/or closing one or more of the following flow paths: a second desired component fluid flow path, a second waste fluid flow path, and a second eluted component fluid flow path, wherein, (hi) if the desired component(s) is not detected, or detected at less than a pre-set value, or (hii) if the second desired component fluid flow time has not elapsed, the second desired component fluid flow path is opened, and the second waste fluid flow path and the second eluted component fluid flow path are closed; and, (hiii) if the desired component(s) is detected at equal to, or greater than, the pre-set value, or (hiv) if the second desired component fluid flow time has not elapsed, the second desired component fluid flow path is opened or remains open, and the second waste fluid flow path and the second eluted component fluid flow path are closed or remain closed; and, (hv) if after the desired component(s) have previously been detected at equal to, or greater than, the pre-set value, and the desired component(s) is subsequently not detected, or detected at less than the pre-set value, or (hvi) if the second desired component fluid flow time has elapsed, the second desired component fluid flow path and the second eluted component fluid flow path are closed, and the second waste fluid flow path is opened; passing fluid along the opened fluid flow path, wherein, if the second waste fluid flow path is opened, the method includes passing fluid along the second waste fluid flow path into the waste container, and if the second desired component fluid flow path is opened, the method includes passing fluid along the second desired component fluid flow path into the inlet of the tangential fluid flow filter device; and (j) repeating (a)-(i) at least once.

The some embodiments, the methods further comprise (k) closing the first desired component recycle flow path or the first desired component flow path, and the first waste fluid flow path, and opening the first eluted component fluid flow path; and; (l) passing an elution fluid through the first chromatography device, and passing desired component(s) containing elution fluid from the outlet of the first chromatography device along the first eluted component fluid flow path into the eluted component container, and/or further comprise (m) closing the second desired component recycle flow path or the second desired component flow path and the second waste fluid flow path, and opening the second eluted component fluid flow path; and; (n) passing an elution fluid through the second chromatography device, and passing desired component(s) containing elution fluid from the outlet of the second chromatograph device along the second eluted component fluid flow path into the eluted component container.

If desired, some embodiments of the method, particularly some embodiments involving the use of a time control arrangement rather than a sensor, further comprise setting the volumetric concentration factor (VCF) to keep the concentration of the desired (target) component stable at the inlets of the chromatography devices. Flow rates at the inlets and permeate outlet are set to maintain the mass balance of target component in the chromatography system such that mass added via the mixing tank equals the mass removed via the chromatography devices.

Embodiments of methods according to the invention can comprise passing fluid through the first chromatography device and the second chromatography device in parallel.

If desired, embodiments of method according to the invention comprise subjecting one chromatography device to loading while subjecting the other chromatography device to non-loading during chromatography cycle.

A wide variety of chromatography devices including chromatography media are suitable for carrying out the invention, for example, devices including beads (e.g., chromatography columns), or including one or more porous chromatography membranes, or including one or more chromatography monoliths (e.g., polymerized gels, silica columns, ceramics, graphitized carbon). A chromatography device can include any number of, e.g., beads, chromatography membranes or chromatography monoliths. A chromatography device can include a plurality (i.e., two or more) of the same type of media, or different types of media. Alternatively, or additionally, a chromatography device can include a plurality of the same type of media wherein the media have different characteristics, e.g., chromatography types. Suitable chromatography devices are known in the art.

In some embodiments, the chromatography devices, e.g., comprising housings and the chromatography medium or chromatography media sealed therein, are preassembled devices, e.g., wherein the medium/media is/are sealed in the housings by the device manufacturer. In some other embodiments, the medium/media is/are sealed in the housings by the end user. The devices can be suitable for treating a variety of fluids, e.g., to purify and/or concentrate one or more desired materials present in the fluids. For example, the devices can be suitable for treating process fluids such as fluids used in the biopharmaceutical industry, e,g., fluids including desirable material such as proteinaceous material, for example, antibodies (e.g., monoclonal antibodies), or recombinant proteins such as growth factors.

Chromatography devices (e.g., capsules, cartridges, and columns), the housings, membranes, and/or monoliths can have any suitable configuration, including, but not limited to, configurations known in the art. For example, the membranes can be one or more of the following forms: planar, pleated, hollow cylindrical, hollow fiber, stacked, and spiral wound. Illustratively, in one embodiment, the membrane(s) can be in the form of a hollow, generally cylindrical, pleated element. The monoliths can be one or more of the following forms: disk, tube, and column.

Additionally, embodiments of the invention encompass the use of more than first and second chromatography devices, e.g., additional chromatography devices can be arranged in series and/or in parallel.

Thus, for example, fluid comprising at least one desired component can be passed into the inlet of a first chromatography device and through the outlet to the first device and into the inlet of a second chromatography device, and through the outlet of the second device and along an effluent fluid flow path and through a controllable flow control arrangement that opens and/or closes fluid flow paths as described herein. There can be more than two chromatography devices arranged in series. Alternatively, for example, fluid can be passed into the inlets of two or more chromatography devices (e.g., essentially simultaneously) and passed through the outlets of the devices, and combined and passed along an effluent fluid flow path and through a controllable flow control arrangement that opens and/or closes fluid flow paths as described herein.

As noted above, embodiments can include a plurality of types of chromatography devices, e.g., at least one chromatography column; and, at least one chromatography monolith and/or at least one chromatography capsule and/or at least one chromatography cartridge.

The substrate media, e.g., beads, membrane(s), monolith(s), can have any desired characteristics, e.g., chromatography type, and a variety of beads, membranes and monoliths (and chromatography devices such as chromatography capsules and chromatography cartridges), including commercially available beads, membranes and monoliths (and commercially available chromatography devices containing such membranes or monoliths), can be used in accordance with the invention, and are known in the art. For example, a variety of ion-exchange beads, membranes and/or monoliths, including a variety of commercially available ion-exchange beads, membranes and/or monoliths, can be used. In some embodiments, the media can function under physiological pH and/or ionic strength. Suitable beads (e.g., resins), membranes and/or monoliths include charged (e.g., a positively charged or a negatively charged media), mixed-mode chromatography media, hydrophobic interactive chromatography (HIC) media, affinity chromatography (e.g., immobilized metal affinity chromatography (IMAC)) media, biospecific (e.g., immobilized Protein A) affinity chromatography media, hydrophobic charge induction chromatography (HOC) media, and a thiophilic chromatography (TC) media.

A variety of filtration devices comprising a housing comprising at least one inlet and at least one outlet, and defining a fluid flow path between the inlet and the outlet, and at least one porous membrane across the fluid flow path, are suitable and are known in the art. Preferably, the each filtration devices comprises a tangential flow filtration (TFF) device (in some embodiments, a single pass (SP) TFF device), and a variety of TFF devices are suitable and are known in the art. Typically, a TFF device, sometimes referred to as a crossflow filter module, comprises a housing comprising at least one inlet and at least a first outlet (e.g., “a permeate outlet”) and a second outlet (e.g., “a concentrate outlet” or a “retentate outlet”) and defining at least a first fluid flow path between the inlet and the first outlet, and a second fluid flow path between the inlet and the second outlet, the device further comprising at least one porous filter element comprising one or more porous membrane(s) (including hollow fiber membranes) across the first fluid flow path. As will be described in more detail below, in accordance with embodiments of the invention, a TFF device can be operated upstream of, and/or downstream of, a chromatography device.

A variety of sensors are suitable and are known in the art. Suitable sensors include, for example, spectrometer flow cells and detectors used in spectroscopy, such as UV, infra-red, NIR, X-ray, visible, fluorescence, NMR, and Raman detectors.

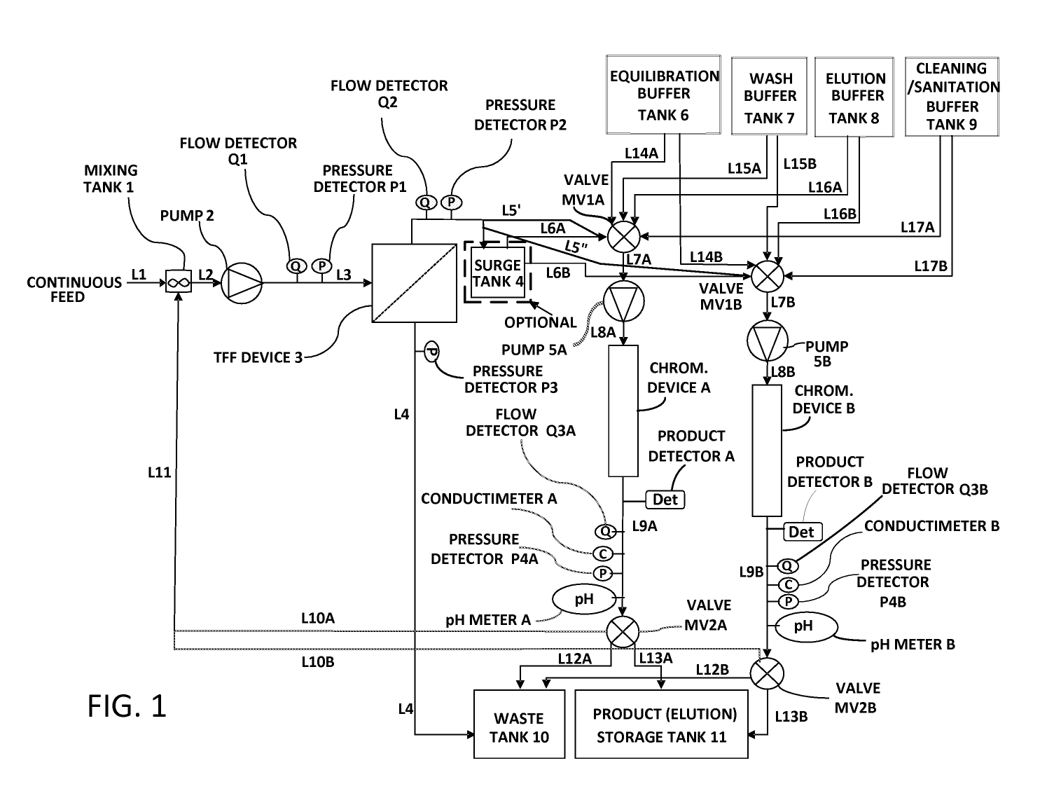

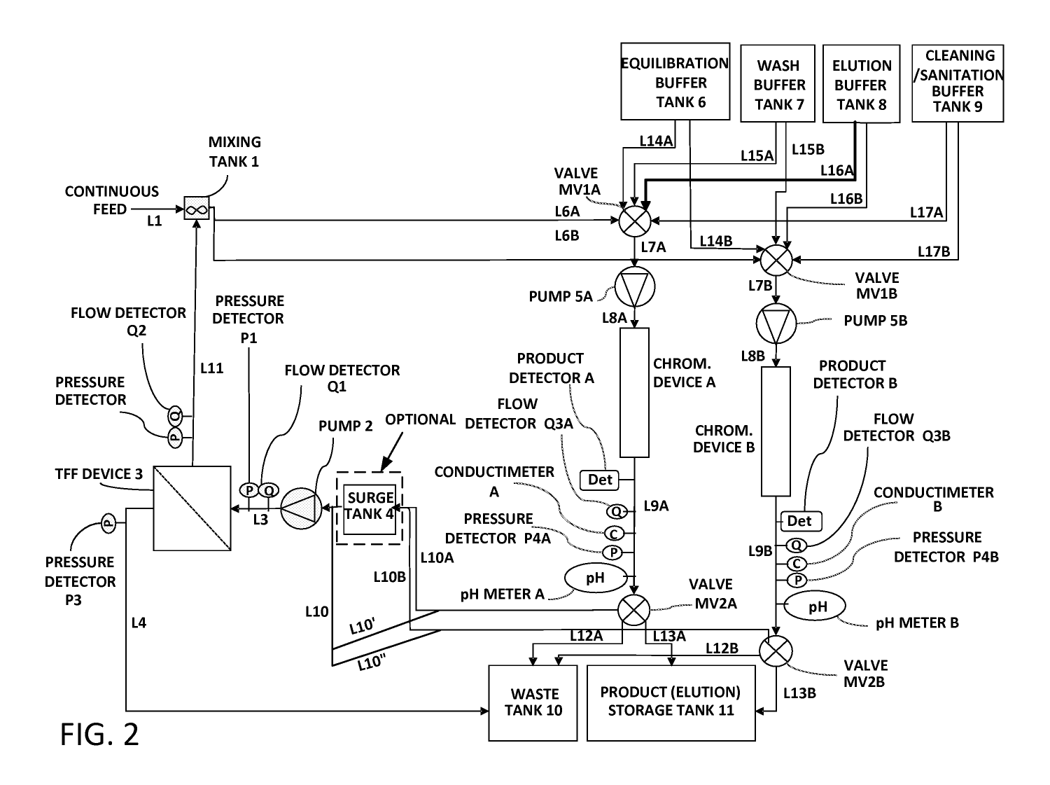

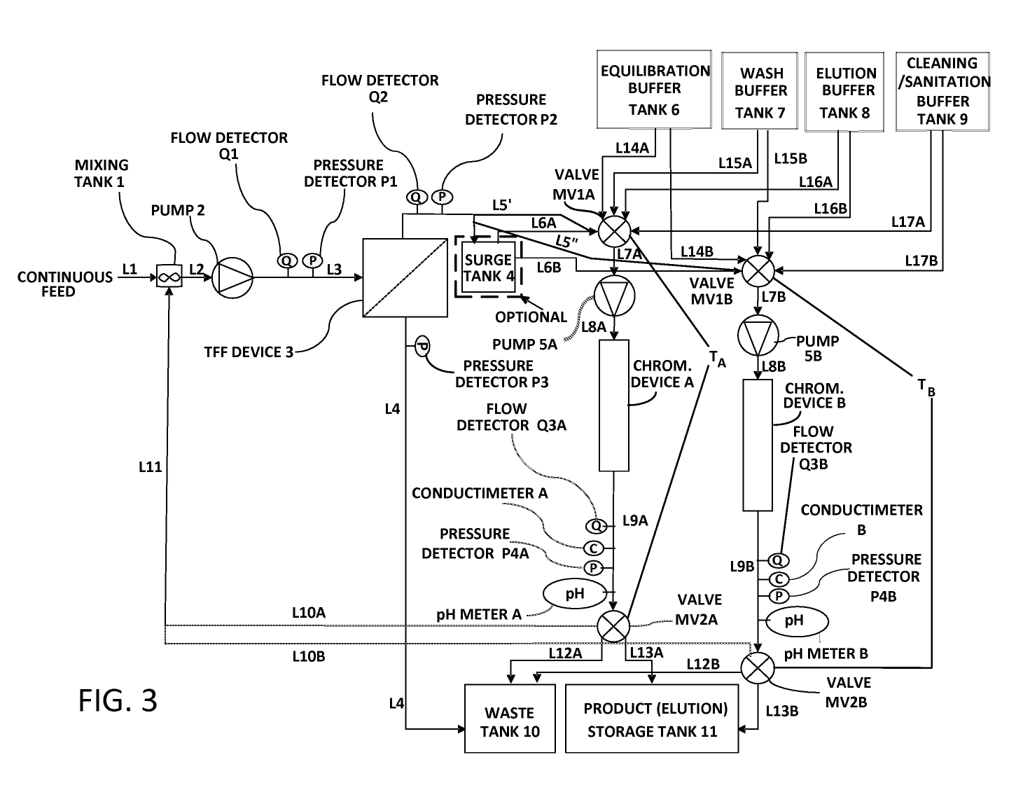

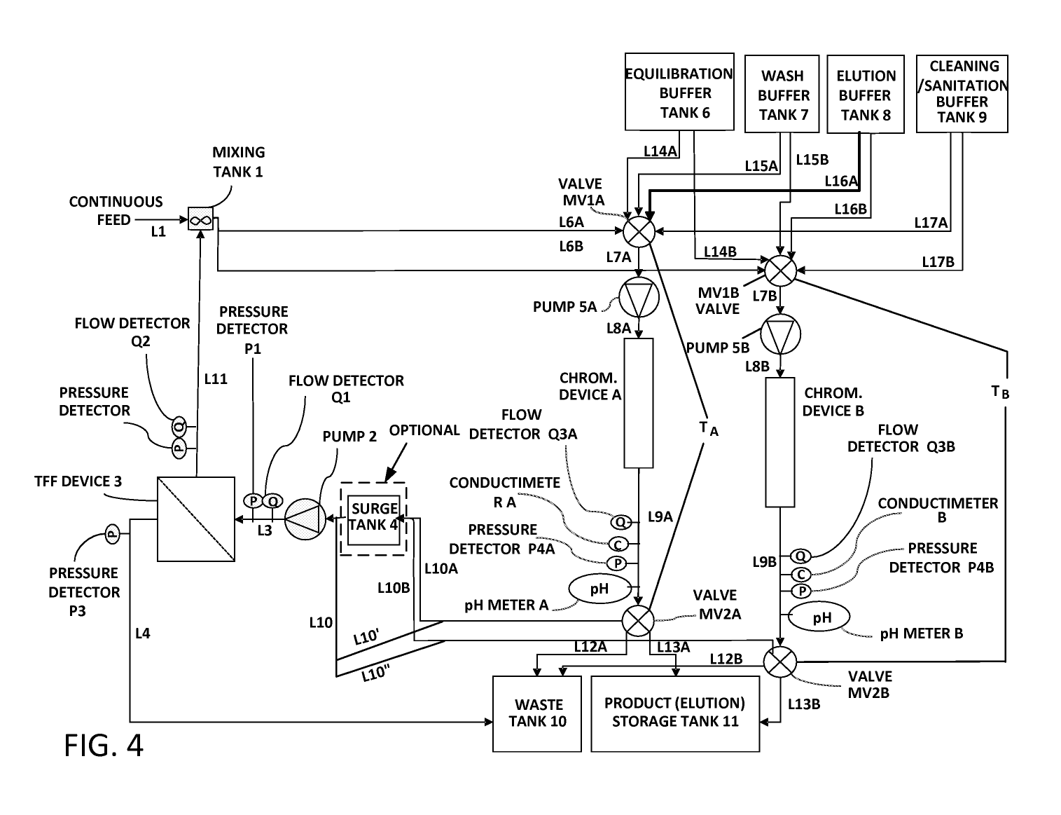

Embodiments of the system typically include a plurality of pumps, such as variable speed pumps. Typically, as illustrated in the Figures, the systems include at least three pumps (2, 5A, 5B), illustrated in FIGS. 1 and 3 as interposed between the mixing container 1 (mixing tank) and the inlet of the TFF device 10, and between the upstream flow control arrangements (MV1A and MV1B) and the inlets of the first and second chromatography devices (A, B), and illustrated in FIGS. 2 and 4 as interposed between the upstream flow control arrangements (MV1A and MV1B) and the inlets of the first and second chromatography devices (A, B), and the downstream control arrangements (MV2A and MV2B) and the inlet the TFF device 10 (if the optional surge tank 4 is used, pump 2 is interposed between the surge tank and the inlet the TFF device). Suitable pumps are known in the art.

A variety of controllable fluid flow arrangements comprising valves (including manually controllable and software controllable fluid flow arrangements) are suitable, and are known in the art. The system can include any number of controllable fluid flow arrangements upstream and/or downstream of the chromatography devices. Preferably, as illustrated in the Figures, the systems include at least first and second downstream controllable fluid flow arrangements downstream of the respective chromatography devices, and at least first and second upstream controllable fluid flow arrangements upstream of the chromatography devices, wherein the upstream controllable fluid flow arrangements are in fluid communication with the inlets of the first and second chromatography devices.

Preferably, in the embodiments of the system illustrated in the Figures, the upstream controllable fluid flow arrangements are in fluid communication with various buffer containers, shown as equilibration buffer tank 6, wash buffer tank 7, elution buffer tank 8, and cleaning/sanitation buffer 9.

A variety of time control arrangements are suitable, and are known in the art. For example, a time control arrangement can comprise software monitoring the time and/or a time control arrangement can comprise a device such as a timer. While the FIGS. 2 and 4 illustrate time control arrangement “T” (“T_{A}” and “T_{B}”) in relation to upstream and downstream flow control arrangements MV1 and MV2 (“MV1A,” “MV2A,” “MV1B,” and “MV2B”), this is merely a diagrammatic illustration encompassing software and/or a specific device.

If desired, the system can include one or more of any of the following: a pressure detector (e.g., a pressure gauge), a flow detector, a conductivity detector, and a pH detector, as is/are known in the art. While not required, the exemplary systems illustrated in the Figures include a plurality of pressure detectors (“P,” shown as P1, P2, P3, P4A, and P4B) and pH detectors (“pH,” shown as pH meter A and pH meter B), a plurality of flow detectors (“Q,” shown as flow detector Q1, Q2, Q3A and Q3B), and a plurality of conductivity detectors (“C,” shown as conductimeter A and conductimeter B).

The chromatography devices can be of any suitable dimensions and volumes. With respect to chromatography columns and/or monoliths, for example, separations on a laboratory scale may warrant a column volume as small as, for example, about 1 milliliter or even about 1 microliter. Large scale purification and isolation of desired components can be performed on columns and/or monoliths as large as, for example, about 5000 liters. More typical volumes are, for example, between 1 liter and 100 liters.

The systems and methods of the present invention can be used to separate and, if desired, purify, a variety of desired components, including biologically relevant molecules and biological substances such as antibodies, proteins, glycoproteins, fusion proteins, recombinant proteins, tagged proteins, enzymes and biological catalysts, peptides, cells, bacteria, viruses, virus-like particles (VLPs), vaccines, nucleic acids, carbohydrates, and lipids. Other substances that are suitable for separation (and, if desired, purification) include oligo- and polysaccharides, lipopolysaccharides, polypeptides, and synthetic soluble polymers. The desired components (e.g., biological substances) typically derive from, or are contained in, sources including but not limited to liquid samples such as saliva, biological fluid, urine, lymphatic fluid, prostatic fluid, seminal fluid, milk, milk whey, organ extracts, plant extracts, cell extracts, cell cultures (including cell lines), fermentation broths, serum, ascites fluid, and transgenic plant and animal extracts. As used herein, a biological fluid includes any treated or untreated fluid associated with living organisms, particularly blood, including whole blood, warm or cold blood, cord blood, and stored or fresh blood; treated blood, such as blood diluted with at least one physiological solution, including but not limited to saline, nutrient, and/or anticoagulant solutions; blood components, such as platelet concentrate (PC), platelet-rich plasma (PRP), platelet-poor plasma (PPP), platelet-free plasma, plasma, fresh frozen plasma (FFP), components obtained from plasma, packed red cells (PRC), transition zone material or huffy coat (BC); blood products derived from blood or a blood component or derived from bone marrow; leukocytes, stem cells; red cells separated from plasma and resuspended in a physiological solution or a cryoprotective fluid; and platelets separated from plasma and resuspended in a physiological solution or a cryoprotective fluid. A biological fluid also includes a physiological solution comprising a bone marrow aspirate. The biological fluid may have been treated to remove some of the leukocytes before being used according to the invention. Blood product or biological fluid refers to the components described above, and to similar blood products or biological fluids obtained by other means and with similar properties.

in this context, one preferred class of biological substances is immunoglobulins. The “immunoglobulins” category embraces whole immunoglobulins, including monoclonal and polyclonal antibodies, as well as Fab, F(ab′)₂, F_{c} and Fᵥ fragments, and other engineered antibody species. In an embodiment, the immunoglobulin may be immunoglobulin G (IgG). Alternatively, or additionally, one or more of any of the following: IgA, IgM, IgD and IgE, can be bound. In some embodiments, IgA and/or IgM are selectively bound.

In accordance with embodiments of the invention, the systems (e.g., the chromatography devices and TFF device) are equilibrated with a buffer before carrying out embodiments of the method. Suitable equilibration buffers and methods are known in the art.

Typically, in carrying out embodiments of the method, the contents of the mixing container are mixed as appropriate, and fluid (e.g., feed) is passed to the chromatography devices at a predetermined flow rate, and the fluid contacts the chromatography media for a period of time sufficient to allow at least one desired component (e.g., at least one desired biological substance) to bind to the medium. Typically, the contact period is between about 30 seconds to about 12 hours.

If appropriate, the pH, ionic strength, or both, of the liquid may be adjusted prior to placing the liquid in contact with the chromatography media. Additionally, or alternatively, the liquid may be concentrated, diluted, or mixed with additives such as salts. Typical capture pH values for a range of proteins is from about 4 to about 10, although the capture pH can be higher or lower. Typically, a pH in the range of about 4 to about 8 promotes protein adsorption to those media that include a cation exchange moiety, while a pH in the range of about 6 to about 10 will accomplish the same where anion exchange moieties are used. In some embodiments, the media may bind proteins at a pH of about 5.5; or at a pH of about 7.2; or at a pH of about 8.0. However, the media can bind proteins at higher or lower pH.

Methods according to embodiments of the invention are not limited by the ionic strength of the fluid, and can be used with fluid having low and high ionic strengths. Many biological substances will readily adsorb to the media at physiological ionic strength. Physiological ionic strength typically ranges from about 15 to about 20 mS/cm, although the ionic strength can be greater or lesser than those value. Typical salt concentrations that correspond to this range fall within about 0.1 to about 0.2 M, preferably 0.14 to about 0.17 M.

The temperature at which the fluid is placed in contacted with the media varies between fluids and a given chromatographic material as is known in the aft. Preferably, the temperature is ambient, but it can be higher or lower than ambient.

After the fluid has contacted the media, the media are preferably washed with an equilibration buffer as is known in the art. An equilibration buffer is a buffer that is preferably of the pH at which the fluid was contacted with the media. Furthermore, the equilibration buffer washes from the media substances that do not adsorb to the medium. Suitable equilibration buffers are known in the art, and include, for example, acetate buffer and phosphate buffered saline,

The desired component(s) typically adsorb(s) to the media. In other embodiments, the desired component(s) may be removed in, for example, the equilibration buffer washing. In this case, the component(s) may be isolated from the buffer by methods known in the art. In another embodiment, the desired component(s) do not adsorb to the substrate, but the impurity to be removed does adsorb to the substrate. In this case, the desired component(s) may be recovered from the loading buffer or washing buffer by methods known in the art.

Components that are adsorbed to the media are subsequently desorbed in one embodiment by adjusting the pH to a value where the substance desorbs. The pH at which desorption occurs will depend upon the substance and upon a given media. For example, for media that comprise an anion exchange moiety, desorption typically occurs over a pH gradient starting at about pH 8 and decreasing to about pH 3. For media that comprise a cation exchange moiety, the pH gradient applied typically starts at about pH 4 and is increased to about pH 11. For media that feature primarily hydrophobic groups, the pH gradient for desorption typically starts at about pH 7 and is decreased to about pH 3. For media that feature primarily hydrophobic groups, preferably an ionic strength gradient is also applied as described below. The pH can be adjusted by any routinely available reagent, such as aqueous solutions of Tris-HCl or carbonate buffers.

In some instances, as mentioned above, adjustment of the eluant ionic strength can increase effectiveness of the media. Thus, for media that comprise primarily hydrophobic groups, the ionic strength can be decreased concomitantly with pH. This is especially so for materials that additionally comprise —NH— moieties, which can give rise to mild ionic charges that become more effective as the ionic strength is decreased. The use of salt gradients is well-known in the art. Typically, salt concentrations for the present media need not exceed about 1.0 M, or about 0.5 M.

Typically, the desorbed desired component is subsequently collected, and can be further processed if desired. Typical purifies of desired components, such as antibodies, that arc purified in accordance with embodiments of the invention are about 70% or more, in some embodiments about 85% or more, and more preferably about 90% to about 99%.

Typically, chromatography cycles are repeated until the an acceptable amount of desired component is bound and eluted with minimal amount of desired component remaining in the system.

In those embodiments wherein a detector is not used, e.g., the method is carried out using a time control flow arrangement, a reference standard (e.g., a reference elution pattern, for example, establishing the compound of interest breakthrough profile from the chromatography device) is first determined, and the results are used to determine the number of chromatography cycles to process specific feed and time length for each of the operations in each of the cycles.

Typically, as part of cleaning and/or sanitation, fluid such as cleaning and/or sanitation buffer is passed from separate containers to each of the upstream flow control arrangements, and from the respective flow control arrangements to the respective chromatography devices. If desired however, fluid (such as cleaning and/or sanitation buffer) can be passed from one flow control arrangement to another, e.g., via a separate conduit communicating with the flow control arrangements, and the fluid can be passed to, for example, a waste container.

The following examples further illustrate the invention but, of course, should not be construed as in any way limiting its scope. In these examples, feed is continuously passed into the mixing tank along line 1, and the feed is mixed with fluid passed along a desired component recycle fluid flow path, which may be retentate fluid, as noted in more detail below.

In Examples 3 and 4, referring to FIGS. 3 and 4 respectively, “T_{A}” and “T_{B}” are controlled by the same software program, and are merely identified as subsets “T_{A}” and “T_{B}” to show the operation of the first and second chromatography columns, rather than to represent separate devices.

With the exceptions of references to the detector and time control arrangements, the system component identifiers are the same for Example 1(referring to FIG. 1) and Example 3 (referring to FIG. 3), and are the same for Example 2 (referring to FIG. 2) and Example 4 (referring to FIG. 4).

### EXAMPLE 1

This example demonstrates the use of a TFF device upstream of first chromatography and second chromatography columns, in accordance with au embodiment of the invention.

A system is arranged as generally shown in FIG. 1. The chromatography sorbent within the columns and the TFF device are equilibrated using the standard practice in the art before initiating the process operation.

A feed sample solution containing the desired component (target molecule) and impurities is continuously pumped along line 1 to the mixing tank 1 and from the mixing tank along lines L2 and L3 to the inlet of the TFF device 3.

The feed sample solution is passed through the inlet and tangentially across the surface of the porous filter element within the TFF device. Molecules smaller than the filter element pores pass through the element (i.e., providing the permeate) and molecules larger than the pores of the filter element are retained and enriched in fraction at the surface of the porous filter (i.e., providing the retentate). The target molecule and impurities larger than filter element pores are retained at the surface of the porous filter element pass through the second outlet (retentate outlet) of the filtration device. Impurities smaller than the filter element pores pass through the porous filter and pass through the first outlet (permeate outlet) of the filtration device along a second waste fluid flow path (TFF waste fluid flow path) via line L4 to the waste tank 10.

The retentate from the TFF device, containing the target molecule and impurities larger than filter element pores, passes through the retentate outlet along lines L5′, L7A, and L8A into the inlet of the first chromatography column A and sample is loaded onto the first chromatography column. Optionally, a surge tank 4 can be used between the retentate outlet of the TFF device and the inlet of the first chromatography column (and the inlet of the second chromatography column), such that retentate passes along line 5′ into the surge tank before loading the first chromatography column via lines L6A, L7A, and L8A.

The retentate, containing the target molecule and some impurities, passes into the first chromatography column and contacts the first sorbent, wherein some of the retentate including the target molecule binds to the sorbent and most of the other retentate (i.e., providing the effluent) including impurities and possibly some target, exits the first chromatography column through the first chromatography column outlet and passes along line L9A and the first column effluent fluid flow path and is directed via line L12A along a first column waste fluid flow path to the waste tank 10.

When the first product detector (sensor) positioned downstream of the outlet of the first chromatography column detects the presence of the target molecule in the effluent from the first chromatography column, this effluent is re-directed from the first effluent fluid flow path via lines L10A and L11 along a first desired component recycle fluid flow path to the mixing tank 1 where it is mixed with additional feed sample solution, and the mixture is directed along lines L2 and L3 to the inlet of the TFF device.

When the first detector detects a level of the target molecule that equals or exceeds a pre-set value, corresponding to when the desired amount of target molecule is bound onto the first chromatography sorbent (i.e., the desired amount is the binding capacity of the first sorbent) within the first chromatography column, the feed sample load is stopped on the first chromatography column. After this is completed, a flush procedure is initiated on the first chromatography column, and the retentate from the TFF device is directed along lines L5″, L7B and L8B to the inlet of the second chromatography column B and sample is loaded onto the second chromatography column (If the optional surge tank 4 is present, retentate can be passed along line L5″ into the tank and along lines L6B, L7B and L8B before loading the second chromatography column).

Equilibration buffer is pumped from the equilibration buffer tank 6 along lines L14A, L7A, and L8A to the inlet of the first chromatography column, wherein the buffer displaces unbound target molecule and impurities and passes them to the outlet of the first chromatography column and via line L9A along the first column effluent fluid flow path and the flow is directed along the first desired component recycle flow path via lines L10A and L11 to the mixing tank 1, where it is mixed with additional feed sample solution, and the mixture is directed to the inlet of the TFF device. The flow through the first chromatography column remains unchanged until the first detector fails to detect the target molecule or the detectable amount does not reach a pre-set value. The effluent from the outlet of the first chromatography column is directed via line L9A along the first column effluent fluid flow path and via line L12A along the first column waste fluid flow path to the waste tank 10.

While the first chromatography column is being operated (flushed) as described above, retentate from the TFF device is directed along lines L5″, L7B mud L8B (or along lines L5″ L6B, L7B and L8B if the optional surge tank 4 is used) to the inlet of the second chromatography device B and sample is loaded onto the second chromatography device.

The retentate, containing the target molecule and some impurities, passes into the second chromatography column and contacts the second sorbent, wherein some of the retentate including the target molecule binds to the sorbent and most of the other retentate (i.e., providing the effluent) including impurities and possibly some target, exits the second chromatography column through the second chromatography column outlet and passes along line L9B and the second column effluent fluid flow path and is directed via line L12B along the second column waste fluid flow path to the waste tank 10.

When the second product detector (sensor) positioned downstream of the outlet of the second chromatography column detects the presence of the target molecule in the effluent from the second chromatography column, this effluent is re-directed from the second column effluent fluid flow path via lines L10B and L11 along a second desired component recycle fluid flow path to the mixing tank 1, where it is mixed with additional feed sample solution, and the mixture is directed along lines L2 and L3 to the inlet of the TFF device.

After the effluent from the outlet of the first chromatography device has been directed to the waste tank, a wash procedure is initiated on the first chromatography column. The wash buffer is pumped from the wash buffer tank 7 along lines L15A, L7A and L8A to the inlet of the first chromatography column. This releases some impurities that are weakly bound on the first chromatography sorbent while the feed sample is applied on the first chromatography column. The target molecule, which is captured during this period, remains bound. The effluent from the outlet of the first chromatography column is still directed along the first column waste fluid flow path to the waste tank 10 during the wash procedure.

After a pre-defined amount of time, an elution procedure is initiated on the first chromatography column. The elution buffer is pumped from the elution buffer tank 8 along lines L16A, L7A, and L8A to the inlet of the first chromatography column. Simultaneously, flow from the outlet of the first chromatography column is directed from the first column effluent fluid flow path along a first column eluted fluid flow path via line L13A to the product tank 11 (elution storage tank) to collect the purified target molecule eluted from first chromatography sorbent.

When the first detector positioned downstream of the first chromatography column fails to detect the target molecule or the detectable amount does not reach a preset value, indicating the target molecule is completely eluted from the first chromatography column, a cleaning procedure is initiated on the first chromatography column. The cleaning solution is pumped from the cleaning solution tank 9 via lines L17A, L7A, and L8A to the inlet of the first chromatography column. Simultaneously, flow from the outlet of the first chromatography column is directed from the first column effluent fluid flow path and along the first column waste fluid flow path via line L12A to the waste tank 10.

After a pre-defined amount of time, corresponding to the time required to completely remove any bound material from the first chromatography column, a re-equilibration procedure is initiated on the first chromatography column. The equilibration buffer is pumped from the equilibration buffer tank 6, via lines L14A, L7A, and L8A to the inlet of the first chromatography column. Flow from the outlet of the first chromatography column remains directed along the first column waste fluid flow path to the waste tank 10 during the re-equilibration procedure. Equilibration buffer is delivered to the first chromatography column for a pre-defined amount of time. At this point a first process cycle is completed on the first chromatography column.

After the first process cycle is completed on the first chromatography column, and when the second detector detects a level of the target molecule that equals or exceeds a pre-set value, corresponding to when the desired amount of target molecule is bound onto the second chromatography sorbent the desired amount is the binding capacity of the second sorbent) within the second chromatography column, the feed sample load is stopped on the second chromatography column. After this is completed, a flush procedure is initiated on the second chromatography column, and the retentate from the second outlet of the TFF device is directed via lines L5′, L7A and L8A to the inlet of the first chromatography column.

At this point, a new process cycle starts on the first chromatography column while the second chromatography column is going through the flush, wash, elution, cleaning, and re-equilibration procedures described above.

With respect to the flush procedure initiated on the second chromatography column, equilibration buffer is pumped from the equilibration buffer tank 6 via lines 14B, 7B and 8B to the inlet of the second chromatography column, wherein the buffer displaces unbound target molecule and impurities and passes them to the outlet of the second chromatography column and via line L9B along the second column effluent fluid flow path and the second desired component recycle flow path via lines L10B and L11 to the mixing tank 1, where it is mixed with additional feed sample solution, and the mixture is directed to the inlet of the TFF device. The flow through the second chromatography device remains unchanged until the second detector fails to detect the target molecule or the detectable amount does not reach a pre-set value. The effluent from the outlet of the second chromatography device is directed from the second column effluent fluid flow path and along the second column waste fluid flow path via line L12B to the waste tank 10.

While equilibrium buffer is pumped to the second chromatography column retentate from the second outlet of the TFF device is directed to the inlet of the first chromatography column.

The retentate, containing the target molecule and some impurities, passes into the first chromatography column and contacts the first sorbent, wherein some of the retentate including the target molecule binds to the sorbent and most of the other retentate (i.e., providing the effluent) including impurities and possibly some target, exits the first chromatography column through the first chromatography column outlet and passes along the first column effluent fluid flow path and is directed along the first column waste fluid flow path via line L12A to the waste tank 10.

When the first product detector (sensor) positioned downstream of the outlet of the first chromatography column detects the presence of the target molecule in the effluent from the first chromatography column, this effluent is re-directed from the first effluent fluid flow path along the first desired component recycle fluid flow path via lines L10A and L11 to the mixing tank, where it is mixed with additional feed sample solution, and the mixture is directed to the inlet of the TFF device.

After the effluent from the outlet of the second chromatography column has been directed along the second column waste fluid flow path to the waste tank, awash procedure is initiated on the second chromatography column. The wash buffer is pumped from the wash buffer tank 7 via lines L15B, L7B, and L8B to the inlet of the second chromatography column. This releases some impurities that are weakly bound on the second chromatography sorbent while the feed sample is applied on the second chromatography column. The target molecule, which is captured during this period, remains bound. The effluent from the outlet of the second chromatography column is still directed along the second column waste fluid flow path to the waste tank during the wash procedure.

After a pre-defined amount of time, an elution procedure is initiated on the second chromatography column. The elution buffer is pumped from the elution buffer tank 8 via L7B, and L8B to the inlet of the second chromatography column.

Simultaneously, flow from the outlet of the second chromatography column is directed from the second column effluent fluid flow path and along the second column eluted fluid flow path via line L13B to the product tank 11 to collect the purified target molecule eluted from the second chromatography sorbent.

When the second detector positioned downstream of the second chromatography column fails to detect the target molecule or the detectable amount does not reach a preset value, indicating the target molecule is completely eluted from the second chromatography column, a cleaning procedure is initiated on the second chromatography column. The cleaning solution is pumped from the cleaning solution tank 9 via lines L17B, L7B, and L8B to the inlet of the second chromatography column. Simultaneously, flow from the outlet of the second chromatography column is directed from the second column effluent fluid flow path and along the second column waste fluid flow path via line L12B to the waste tank 10.

After a pre-defined amount of time, corresponding to the time required to completely remove any bound material from the second chromatography column, a re-equilibration procedure is initiated on the second chromatography column. The equilibration buffer is pumped from the equilibration buffer tank 6 via lines L14B, L7B, and L8B to the inlet of the second chromatography column. Flow from the outlet of the second chromatography column remains directed along the second column waste fluid flow path to the waste tank during the re-equilibration procedure. Equilibration buffer is delivered to the second chromatography column for a pre-defined amount of time. At this point a first process cycle is completed on the second chromatography column.

After the first process cycle is completed on the second chromatography column, and when the first detector detects a level of the target molecule that equals or exceeds a pre-set value, corresponding to when the desired amount of target molecule is bound onto the first chromatography sorbent within the first chromatography column, the feed sample load is stopped on the first chromatography column. After this is completed, a flush procedure is initiated on the first chromatography column, and the retentate from the TFF device is directed to the inlet of the second chromatography device.

At this point, a new process cycle starts on the second chromatography column while the first chromatography column is going through the flush, wash, elution, cleaning, and re-equilibration procedures.

Additional cycles are initiated by repeating cycles as set out above. The retentate from the TFF device is directed to one chromatography column at a time while the other column (or another column if the system includes more than two chromatography columns) is going through the flush, wash, elution, cleaning, and re-equilibration procedures. The process can continue indefinitely by switching a chromatography column in and out of the feed sample load procedure.

At the end of the process the continuous feed flow is stopped. To maintain the volume of liquid in the system, flow from the first (permeate) outlet of the TFF device along the third waste fluid flow path is stopped and the volume in the system remains close to constant. The process is ended when an acceptable amount of target molecule is bound and eluted from the chromatography columns with minimal amount of target molecule remaining in the system.

### EXAMPLE 2

This example demonstrates the use of a TFF device downstream of first chromatography and second chromatography columns, in accordance with an embodiment of the invention,

A system is arranged as generally shown in FIG. 2. The chromatography sorbent within the columns and the TFF device are equilibrated using the standard practice in the art before initiating the process operation.

A feed sample solution containing the desired component (target molecule) and impurities is continuously pumped along line L1 to the mixing tank 1 and from the mixing tank via lines L6A, L7A, and L8A to the inlet of the first chromatography column A, and contacts the first sorbent, wherein some of the feed sample solution including the target molecule binds to the sorbent and most of the other feed sample solution (i,e., providing the effluent) including impurities and possibly some target, exits the first chromatography column through the first chromatography column outlet and passes via line L9A along the first column effluent fluid flow path and is directed via line L12A along the first column waste fluid flow path to the waste tank 10.

When the first product detector (sensor) positioned downstream of the outlet of the first chromatography column detects the presence of the target molecule in the effluent from the first chromatography column, this effluent is re-directed from the first effluent fluid flow path and along the first desired component fluid flow path via lines L10′, L10, and L3 to the inlet of the TFF device 3. Optionally, a surge tank 4 can be used between the outlet of the first chromatography column A (and the outlet of the second chromatography column B) and the inlet of the TFF device 3, such that fluid can be passed into the surge tank (via line L10A) before passing it from the surge tank to inlet of the TFF device.

The re-directed effluent feed sample solution passes along the first desired component fluid flow path through the inlet and tangentially across the surface of the porous filter element within the TFF device. Molecules smaller than the filter element pores pass through the element (i.e., providing the permeate) and molecules larger than the pores of the filter element are retained and enriched in fraction at the surface of the porous filter (i.e., providing the retentate). The target molecule and impurities larger than filter element pores retained at the surface of the porous filter element pass through the second outlet (retentate outlet) of the TFF device and via line L11 along the desired component recycle fluid flow path. Impurities smaller than the filter element pores pass through the porous filter and pass through the first outlet (permeate outlet) of the TFF device along the third waste fluid flow path (TFF waste fluid flow path) via line L4 to the waste tank 10.

The flow from the retentate outlet is directed along the desired component recycle fluid flow path via line L11 to the mixing tank 1 where it is mixed with feed sample solution and directed to the inlet of the first chromatography column.

When the first detector detects a level of the target molecule that equals or exceeds a pre-set value, corresponding to when the desired amount of target molecule is bound onto the first chromatography sorbent (the desired amount equals the binding capacity of the first sorbent) within the first chromatography column, the feed sample load is stopped on the first chromatography column.

After this is completed, a flush procedure is initiated on the first chromatography column, and sample feed solution is directed to the inlet of the second chromatography device B via the mixing tank 1 (continuous feed is mixed with the retentate fluid from the TFF device in the mixing tank) and lines L6B, L7B and L8B, and feed solution is loaded onto the second chromatography column.

With respect to the flush procedure initiated on the first chromatography column, equilibration buffer is pumped from the equilibration buffer tank 6 via lines L14A, L7A, and L8A to the inlet of the first chromatography column, wherein the buffer displaces unbound target molecule and impurities and passes them to the outlet of the first chromatography column and along the first column effluent flow path via line 9A and along the first desired component fluid flow path via lines L10′, L10, and L3 to the inlet of the TFF device. The flow through the first chromatography device remains unchanged until the first detector fails to detect the target molecule or the detectable amount does not reach a pre-set value. The effluent from the outlet of the first chromatography device is directed along the first column effluent flow path and the first column waste fluid flow path via line L12A to the waste tank 10.

While equilibrium buffer is pumped to the first chromatography column, feed sample solution is passed from the mixing tank 1 (continuous feed is mixed with the retentate fluid from the TFF device) via lines L6B, L7B, and L8B and the solution is loaded onto the second chromatography device. The solution contacts the second sorbent, wherein some of the solution including the target molecule binds to the sorbent and most of the other solution (i.e., providing the effluent) including impurities and possibly some target, exits the second chromatography column through the second chromatography column outlet and passes along the second column effluent fluid flow path via line L9B and is directed along the second column waste fluid flow path via line 12B to the waste tank 10.

When the second product detector (sensor) positioned downstream of the outlet of the second chromatography column detects the presence of the target molecule in the effluent from the second chromatography column, this effluent is re-directed from the second effluent fluid flow path and along the second desired component fluid flow path via lines L10″, L10 and L3 to the inlet of the TFF device (if the optional surge tank 4 is present, fluid can be passed into the tank via line L10B and subsequently from the surge tank to the inlet of the TFF device).

After the flush procedure for the first chromatography column is completed, a wash procedure is initiated on the first chromatography column. The wash buffer is pumped from the wash buffer tank 7 via lines L15A, L7A, and L7B to the inlet of the first chromatography column. This releases some impurities that are weakly bound on the first chromatography sorbent while the feed sample solution is applied on the first chromatography column. The target molecule, which is captured during this period, remains bound. The effluent from the outlet of the first chromatography column is still directed along the first column waste fluid flow path to the waste tank 10 during the wash procedure.

After a pre-defined amount of time, an elution procedure is initiated on the first chromatography column. The elution buffer is pumped from the elution buffer tank 8 via lines L16A, L7A and L7B to the inlet of the first chromatography column. Simultaneously, flow from the outlet of the first chromatography column is directed from the first column effluent fluid flow path and along the first column eluted fluid flow path via line L13A to the product tank 11 (elution storage tank) to collect the purified target molecule eluted from the first chromatography sorbent.

When the first detector positioned downstream of the first chromatography column fails to detect the target molecule or the detectable amount does not reach a preset value, indicating the target molecule is completely eluted from the first chromatography column, a cleaning procedure is initiated on the first chromatography column. The cleaning solution is pumped from the cleaning solution tank 9 via lines L17A, L7A and L8A to the inlet of the first chromatography column. Simultaneously, flow from the outlet of the first chromatography column is directed from the first column effluent fluid flow path along the first column waste fluid flow path via line L12A to the waste tank 10.

After a pre-defined amount of time, corresponding to the time required to completely remove any bound material from the first chromatography column, a re-equilibration procedure is initiated on the first chromatography column. The equilibration buffer is pumped from the equilibration buffer tank 6 via lines L14A, L7A, and L8A to the inlet of the first chromatography column. Flow from the outlet of the first chromatography column remains directed along the first column waste fluid flow path to the waste tank during the re-equilibration procedure. Equilibration buffer is delivered to the first chromatography column for a pre-defined amount of time. At this point a first process cycle is completed on the first chromatography column.

After the first process cycle is completed on the first chromatography column, and when the second detector detects a level of the target molecule that equals or exceeds a pre-set value, corresponding to when the desired amount of target molecule is bound onto the second chromatography sorbent (the desired amount is the binding capacity of the second sorbent) within the second chromatography column, the feed sample load is stopped on the second chromatography column. After this is completed, a flush procedure is initiated on the second chromatography column, and the solution is passed along the second column effluent fluid flow path and along the second desired component fluid flow path via lines L10″, L10, and L3 through the TFF device, and flow from the retentate outlet is directed along the desired component recycle fluid flow path via line L11 to the mixing tank 1, where it is mixed with continuous feed to provide feed sample solution, and the solution is directed to the inlet of the first chromatography column.

At this point, a new process cycle starts on the first chromatography column while the second chromatography column is going through the flush, wash, elution, cleaning, and re-equilibration procedures as described above.

With respect to the flush procedure initiated on the second chromatography column, equilibration buffer is pumped from the equilibration buffer tank 6 via lines L14B, L7B and L8B to the inlet of the second chromatography column, wherein the buffer displaces unbound target molecule and impurities and passes them to the outlet of the second chromatography column and the second column effluent fluid flow path and along the second desired component flow path via lines L10″, L10, and L3 (or, if a surge tank 4 is used, via line L10D, the surge tank, and line L3) to the inlet of the TFF device.

The flow through the second chromatography device remains unchanged until the second detector fails to detect the target molecule or the detectable amount does not reach a pre-set value. The effluent from the outlet of the second chromatography device is directed from the second column effluent fluid flow path and along the second column waste fluid flow path via line L12B to the waste tank 10.

While equilibrium buffer is pumped to the second chromatography column, feed sample solution is passed from the mixing tank (continuous feed is mixed with the retentate fluid from the TFF device) and the solution is loaded onto the first chromatography column. The mixture contacts the first sorbent, wherein some of the feed sample solution including the target molecule binds to the sorbent and most of the other feed sample solution (i.e., providing the effluent) including impurities and possibly some target, exits the first chromatography column through the first chromatography column outlet and passes along the first column effluent fluid flow path and is directed along a first column waste fluid flow path via line L12A to the waste tank 10.

When the first product detector (sensor) positioned downstream of the outlet of the first chromatography column detects the presence of the target molecule in the effluent from the first chromatography column, this effluent is re-directed from the first effluent fluid flow path and along the first desired component fluid flow path to the inlet of the TFF device.

After the flush procedure for the second chromatography column is completed, a wash procedure is initiated on the second chromatography column. The wash buffer is pumped from the wash buffer tank 7 via lines L15B, L7B, and L8B to the inlet of the second chromatography column. This releases some impurities that are weakly bound on the second chromatography sorbent while the feed solution is applied on the second chromatography column. The target molecule, which is captured during this period, remains bound. The effluent from the outlet of the second chromatography column is still directed along the second column waste fluid flow path to the waste tank during the wash procedure.

After a pre-defined amount of time, an elution procedure is initiated on the second chromatography column. The elution buffer is pumped from the elution buffer tank 8 via lines L16B, L7B, and L8B to the inlet of the second chromatography column. Simultaneously, flow from the outlet of the second chromatography column is directed from the second column effluent fluid flow path along the second column eluted fluid flow path via line L13B to the product tank 11 to collect the purified target molecule eluted from the second chromatography sorbent.

When the second detector positioned downstream of the second chromatography column fails to detect the target molecule or the detectable amount does not reach a preset value, indicating the target molecule is completely eluted from the second chromatography column, a cleaning procedure is initiated on the second chromatography column. The cleaning solution is pumped from the cleaning solution tank 9 via lines L17B, L7B, and L8B to the inlet of the second chromatography column. Simultaneously, flow from the outlet of the second chromatography column is directed from the second column effluent fluid flow path along the second column waste fluid flow path via line L12B to the waste tank.

After a pre-defined amount of time, corresponding to the time required to completely remove any bound material from the second chromatography column, a re-equilibration procedure is initiated on the second chromatography column. The equilibration buffer is pumped from the equilibration buffer tank 6 via lines L14B, L7B, and L8B to the inlet of the second chromatography column. How from the outlet of the second chromatography column remains directed along the second column waste fluid flow path to the waste tank during the re-equilibration procedure. At this point a first process cycle is completed on the second chromatography column.

After the first process cycle is completed on the second chromatography column, and when the first detector detects a level of the target molecule that equals or exceeds a pre-set value, corresponding to when the desired amount of target molecule is bound onto the first chromatography sorbent within the first chromatography column, the feed sample load is stopped on the first chromatography column. After this is completed, a flush procedure is initiated on the first chromatography column, and the solution is passed along the first column effluent fluid flow path and along the first desired component fluid flow path through the TFF device, and flow from the retentate outlet is directed along the desired component recycle fluid flow path to the mixing tank, where it is mixed with continuous feed to provide feed sample solution, and the solution is directed to the inlet of the second chromatography column.

At this point, a new process cycle starts on the second chromatography column while the first chromatography column is going through the flush, wash, elution, cleaning, and re-equilibration procedures.

Additional cycles are initiated by repeating cycles as set out above. The feed solution (including retentate) is directed via the mixing tank to one chromatography column at a time while the other column (or another column if the system includes more than two chromatography columns) is going through the flush, wash, elution, cleaning, and re-equilibration procedures. The process can continue indefinitely by switching a chromatography column in and out of the feed sample load procedure.

At the end of the process the continuous feed flow is stopped. To maintain the volume of liquid in the system, flow from the first (permeate) outlet of the TFF device along the second waste fluid path is stopped and the volume in the system remains close to constant. The process is ended when an acceptable amount of target molecule is bound and eluted from the chromatography columns with minimal amount of target molecule remaining in the system.

### EXAMPLE 3

This example demonstrates the use of a TFF device upstream of first chromatography and second chromatography columns, using a time control arrangement (without a product detector) in accordance with an embodiment of the invention.

A system is arranged as generally shown in FIG. 3. The chromatography sorbent within the columns and the TFF device are equilibrated using the standard practice in the art before initiating the process operation.

A series of parameters used during the process are deduced from previous reference experiments where feed sample solution containing the desired component (target molecule) and impurities is loaded at different flow rates and concentrations onto a laboratory scale chromatography column to obtain different product breakthrough profiles used to define (i) the VCF to apply on the TFF device to keep the concentration of the target molecule stable at the inlet of the chromatography column, (ii) the time at which the target molecule will break through the chromatography column and (iii) the sample load time to obtain the required binding capacity.

A feed sample solution containing the desired component (target molecule) and impurities is continuously pumped from the mixing tank to the inlet of the TFF device.

The feed sample solution is passed through the inlet and tangentially across the surface of the porous filter element within the TFF device. Molecules smaller than the filter element pores pass through the element (i.e., providing the permeate) and molecules larger than the pores of the filter element are retained and enriched in fraction at the surface of the porous filter (i.e., providing the retentate). The target molecule and impurities larger than filter element pores retained at the surface of the porous filter element pass through the second outlet (retentate outlet) of the TFF device. Impurities smaller than (he filter element pores pass through the porous filter and pass through the first outlet (permeate outlet) of the TFF device along a third waste fluid flow path (TFF waste fluid flow path) to the waste tank.

The TFF device is operated to set the VCF to keep the concentration of the desired (target) component stable at the second outlet (retentate outlet) of the TFF device and consequently at the inlet of the chromatography column. A flow rate is pre-defined, and the flow rate at the second outlet (retentate outlet) of the TFF device is set to match the pre-defined flow rate through the first and second chromatography columns. Flow rates at the TFF inlet and permeate outlet are set to maintain the mass balance of target component in the chromatography system such that mass added via feed sample stream equals the mass removed via the chromatography columns.

The retentate from the TFF device, containing the target molecule and impurities larger than filter element pores, passes through the retentate outlet into the inlet of the first chromatography column and sample is loaded onto the first chromatography device. Optionally, a surge tank can be used between the retentate outlet of the TFF device and the inlet of the first chromatography column (and the inlet of the second chromatography column), such that retentate is passed to the tank before passing it to the inlet of the first chromatography column.

The retentate, containing the target molecule and some impurities, passes into the first chromatography column and contacts the first sorbent, wherein some of the retentate including the target molecule binds to the sorbent and most of the other retentate (i.e., providing the effluent) including impurities and possibly some target, exits the first chromatography column through the first chromatography column outlet and passes along the first column effluent fluid flow path and is directed along a first column waste fluid flow path to the waste tank.

After a pre-defined amount of time, corresponding to the time for the target molecule to break through the first chromatography column, the effluent from the first chromatography column is directed from the effluent fluid flow path along the first desired component recycle fluid flow path to the mixing tank where it is mixed with continuous feed to provide feed sample solution that is directed to the inlet of the TFF device.

After a pre-defined amount of time, corresponding to the time at which the desired amount of target molecule is bound onto the first chromatography sorbent (i.e., desired amount equals binding capacity) within the first chromatography column, the feed sample load on the first chromatography column is stopped. After this is completed, a flush procedure is initiated on the first chromatography column, and the retentate from the TFF device is directed to the inlet of the second chromatography device and sample is loaded onto the second chromatography column.

Equilibration buffer is pumped from the equilibration buffer tank to the inlet of the first chromatography column, wherein the buffer displaces unbound target molecule and impurities and passes them to the outlet of the first chromatography column and along the first desired component recycle flow path to the mixing tank where it is mixed with continuous feed, and the feed sample solution is directed to the inlet of the TFF device. The flow through the first chromatography column remains unchanged for a pre-defined amount of time (for example, the time required to pump a volume of equilibration buffer equivalent to 1.5 times the volume of the first chromatography column). When that time is elapsed, the effluent from the outlet of the first chromatography column is directed from the first column effluent fluid flow path along the first column waste fluid flow path to the waste tank.

While the first chromatography column is being operated (e.g., flushed) as described above, retentate from the TFF device is directed to the inlet of the second chromatography device and sample is loaded onto the second chromatography device.

The retentate, containing the target molecule and some impurities, passes into the second chromatography column and contacts the second sorbent, wherein some of the retentate including the target molecule binds to the sorbent and most of the other retentate (i.e., providing the effluent) including impurities and possibly some target, exits the second chromatography column through the second chromatography column outlet and passes along the second column effluent fluid flow path and is directed along the second column waste fluid flow path to the waste tank.

While equilibrium buffer is pumped to the first chromatography column, retentate from the second outlet of the TFF device is directed to the inlet of the second chromatography column to load sample on the second chromatography column (if the optional surge tank is present retentate can be passed into the tank and fluid can subsequently be passed into the inlet of the second chromatography column.

The retentate, containing the target molecule and some impurities, passes into the second chromatography column and contacts the second sorbent wherein some of the retentate including the target molecule binds to the sorbent and most of the other retentate (i.e., providing the effluent) including impurities and possibly some target, exits the second chromatography column through the second chromatography column outlet and passes along the second column effluent fluid flow path and is directed along the second column waste fluid flow path to the waste tank.

After the flush procedure for the first chromatography column is completed, a wash procedure is initiated on the first chromatography column. The wash buffer is pumped from the wash buffer tank to the inlet of the first chromatography column. This releases some impurities that are weakly bound on the first chromatography sorbent while the target molecule containing fluid is applied on the first chromatography column. The target molecule, which is captured during this period, remains bound. The effluent from the outlet of the first chromatography column is still directed along the first column waste fluid flow path to the waste tank during the wash procedure.

After a pre-defined amount of time, an elution procedure is initiated on the first chromatography column. The elution buffer is pumped from the elution buffer tank to the inlet of the first chromatography column. Simultaneously, flow from the outlet of the first chromatography column is directed from the first effluent fluid flow path along a first eluted fluid flow path to the product tank to collect the purified target molecule eluted from the first chromatography sorbent.

After a pre-defined amount of time, corresponding to the time required to completely eluted any bound material from the first chromatography column, a cleaning procedure is initiated on the first chromatography column. The cleaning solution is pumped from the cleaning solution tank to the inlet of the first chromatography column. Simultaneously, flow from the outlet of the first chromatography column is directed from the first column effluent fluid flow path along the first column waste fluid flow path to the waste tank.

After a pre-defined amount of time, corresponding to the time required to completely remove any hound material from the first chromatography column, a re-equilibration procedure is initiated on the first chromatography column. The equilibration buffer is pumped from the equilibration buffer tank to the inlet of the first chromatography column. Flow from the outlet of the first chromatography column remains directed along the first column waste fluid flow path to the waste tank during the re-equilibration procedure. Equilibration buffer is delivered to the first chromatography column for a pre-defined amount of time. At this point a first process cycle is completed on the first chromatography column.

After the first process cycle is completed on the first chromatography column, and after a pre-defined amount of time, corresponding to the time at which the desired amount of target molecule is bound onto the second chromatography sorbent (desired amount equals binding capacity of the second sorbent) within the second chromatography column, the feed sample load on the second chromatography column is stopped. After this is completed, a flush procedure is initiated on the second chromatography column, and the retentate from the TFF device is directed to the inlet of the first chromatography device and retentate (containing the target molecule) is loaded onto the first chromatography column.

At this point, a new process cycle starts on the first chromatography column while the second chromatography column is going through the flush, wash, elution, cleaning, and re-equilibration procedures as described above.

With respect to the flush procedure initialed on the second chromatography column, equilibration buffer is pumped from the equilibration buffer tank to the inlet of the second chromatography column, wherein the buffer displaces unbound target molecule and impurities and passes them to the outlet of the second chromatography column and along the second desired component recycle flow path to the mixing tank, where it is mixed with continuous feed, and the feed sample solution is directed to the inlet of the TFF device. The flow through the second chromatography column remains unchanged for a pre-defined amount of time (for example, the time required to pump a volume of equilibration buffer equivalent to 1.5 times the volume of the second chromatography column). When that time has elapsed, the effluent from the outlet of the second chromatography column is directed from the second column effluent fluid flow path along the second column waste fluid flow path to the waste tank.

While equilibrium buffer is pumped to the second chromatography column, retentate from the second outlet of the TFF device is directed to the inlet of the first chromatography column.

The retentate, containing the target molecule and some impurities, passes into the first chromatography column and contacts the first sorbent, wherein some of the retentate including the target molecule binds to the sorbent and most of the other retentate (i.e., providing the effluent) including impurities and possibly some target, exits the first chromatography column through the first chromatography column outlet and passes along the first column effluent fluid flow path and is directed along the first column waste fluid flow path to the waste tank.

After a pre-defined amount of time, corresponding to the time for the target molecule to break through the first chromatography column, the effluent from the first chromatography column is directed from the first column effluent fluid flow path along the first desired component recycle fluid flow path to the mixing tank where it is mixed with continuous feed and directed to the inlet of the TFF device.

After flushing of the second chromatography column has been completed, a wash procedure is initiated on the second chromatography column. The wash buffer is pumped from the wash buffer tank to the inlet of the second chromatography column. This releases some impurities that are weakly bound on the second chromatography sorbent while the retentate is applied on the second chromatography column. The target molecule, which is captured during this period, remains bound. The effluent from the outlet of the second chromatography column is still directed along the second column waste fluid flow path to the waste tank during the wash procedure.

After a pre-defined amount of time, an elution procedure is initiated on the second chromatography column. The elution buffer is pumped from the elution buffer tank to the inlet of the second chromatography column. Simultaneously, flow from the outlet of the second chromatography column is directed from the second column effluent fluid flow path along the second column eluted fluid flow path to the product tank to collect the purified target molecule eluted from the second chromatography sorbent.

After a pre-defined amount of time, corresponding to the time required to completely eluted any bound material from the second chromatography column, a cleaning procedure is initiated on the second chromatography column. The cleaning solution is pumped from the cleaning solution tank to the inlet of the second chromatography column. Simultaneously, flow from the outlet of the second chromatography column is directed from the second column effluent fluid flow path along the second column waste fluid flow path to the waste tank.

After a pre-defined amount of time, corresponding to the time required to completely remove any bound material from the second chromatography column, a re-equilibration procedure is initiated on the second chromatography column. The equilibration buffer is pumped from the equilibration buffer tank to the inlet of the second chromatography column. Flow from the outlet of the second chromatography column remains directed along the second column waste fluid flow path to the waste tank during the re-equilibration procedure. Equilibration buffer is delivered to the second chromatography column for a pre-defined amount of time. At this point a first process cycle is completed on the second chromatography column.

After the first process cycle is completed on the second chromatography column, and after a pre-defined amount of time, corresponding to the time at which the desired amount of target molecule is bound onto the first chromatography sorbent within the first chromatography column, the retentate load on the first chromatography column is stopped. After this is completed, a flush procedure is initiated on the first chromatography column, and the retentate from the TFF device is directed to the inlet of the second chromatography column and retentate is loaded onto the second chromatography column.

At this point, a new process cycle starts on the second chromatography column while the first chromatography column is going through the flush, wash, elution, cleaning, and re-equilibration procedures.

Additional cycles are initiated by repeating cycles as set out above. The retentate from the TFF device is directed to one chromatography column at a time while the other column (or another column if the system includes more than two chromatography columns) is going through the flush, wash, elution, cleaning, and re-equilibration procedures. The process can continue indefinitely by switching a chromatography column in and out of the feed sample load procedure.

At the end of the process the continuous feed flow is stopped. To maintain the volume of liquid in the system, flow from the first (permeate) outlet of the TFF device along the third waste fluid path is stopped and the volume in the system remains close to constant. The process is ended when an acceptable amount of target molecule is bound and eluted from the chromatography columns with minimal amount of target molecule remaining in the system.

### EXAMPLE 4

This example demonstrates the use of a TFF device downstream of first chromatography and second chromatography columns, using a time control arrangement (without a product detector) in accordance with an embodiment of the invention.

A system is arranged as generally shown in FIG. 4. The chromatography sorbent within the columns and the TFF device are equilibrated using the standard practice in the art before initiating the process operation.

A series of parameters used during the process are deduced from previous reference experiments where feed sample solution containing the desired component (target molecule) and impurities is loaded at different flow rates and concentrations onto a laboratory scale chromatography column to obtain different product breakthrough profiles used to define (i) the VCF to apply on the TFF device to keep the concentration of the target molecule stable at the inlet of the chromatography column, (ii) the time at which the target molecule will break through the chromatography column and (iii) the sample load time to obtain the required binding capacity.

A feed sample solution containing the desired component (target molecule) and impurities is continuously pumped from the mixing tank to the inlet of the first chromatography column, and contacts the first sorbent, wherein some of the feed sample solution including the target molecule binds to the first sorbent and most of the other feed sample solution (i.e., providing the effluent) including impurities and possibly some target, exits the first chromatography column through the first chromatography column outlet and passes along the first column effluent fluid flow path and is directed along a first column waste fluid flow path to the waste tank.

After a pre-defined amount of time, corresponding to the time for the target molecule to break through the first chromatography column, the effluent from the first chromatography column is directed from the first column effluent fluid flow path along the first desired component fluid flow path to the inlet of the TFF device. Optionally, a surge tank can be used between the outlet of the first chromatography column (and the outlet of the second chromatography column) and the inlet of the TFF device, such that fluid can be passed into the surge tank and subsequently passed to the inlet of the TFF device.

The re-directed effluent passes through the inlet and tangentially across the surface of the porous filter element within the TFF device. Molecules smaller than the filter element pores pass through the element (i.e., providing the permeate) and molecules larger than the pores of the filter element are retained and enriched in fraction at the surface of the porous filter (i.e., providing the retentate). The target molecule and impurities larger than filter element pores retained at the surface of the porous filter element pass through the second outlet (retentate outlet) of the TFF device, and along the desired component recycle fluid flow path to the mixing tank. Impurities smaller than the filter element pores pass through the porous filter and pass through the first outlet (permeate outlet) of the TFF device along a third waste fluid flow path (TFF waste fluid flow path) to the waste tank. The flow from the retentate outlet is directed along the desired component recycle fluid flow path to the mixing tank where it is mixed with continuous feed to provide a feed sample solution that is directed to the inlet of the first chromatography column.

The TFF device is operated to set the VCF to keep the concentration of the desired (target) component stable at the inlets of the chromatography columns. The flow rate at the inlet of a TFF device is defined by the flow rate through the chromatography columns. The flow rate at the first (permeate) outlet of the TFF device is equal to the flow rate of the feed sample solution and is set to maintain the mass balance of target component in the chromatography system such that mass added via feed sample stream equals the mass removed via the chromatography columns.

After a pre-defined amount of time, corresponding to the time at which the desired amount of target molecule is bound onto the first chromatography sorbent (i.e., desired amount equals binding capacity) within the first chromatography column, the feed solution load on the first chromatography column is stopped. After this is completed, a flush procedure is initiated on the first chromatography column, and the feed solution is directed to the inlet of the second chromatography device via the mixing tank (continuous feed is mixed with the stream from the TFF retentate outlet in the mixing tank) and feed solution is loaded onto the second chromatography device.

With respect to the flush procedure initiated on the first chromatography column, equilibration buffer is pumped from the equilibration buffer tank to the inlet of the first chromatography column, wherein the buffer displaces unbound target molecule and impurities and passes them to the outlet of the first chromatography column and along the first desired component flow path to the inlet of the TFF device. The flow through the first chromatography device remains unchanged for a pre-defined amount of time (for example, the time required to pump a volume of equilibration buffer equivalent, to 1.5 times the volume of the first chromatography column). When that time has elapsed, the effluent from the outlet of the first chromatography column is directed from the first column effluent fluid flow path along the first column waste fluid flow path to the waste tank.

While the first chromatography column is being operated (flushed) as described above, continuous feed, containing the target molecule and impurities, is passed though the mixing tank (where it is mixed with retentate passing along the desired component fluid flow path from the TFF device), and the feed solution is directed to the inlet of the second chromatography column and feed solution is loaded onto the second chromatography column.

The feed solution, containing the target molecule and some impurities, passes into the second chromatography column and contacts the second sorbent, wherein some of the feed sample solution including the target molecule binds to the sorbent and most of the other feed sample solution (i.e., providing the effluent) including impurities and possibly some target, exits the second chromatography column through the second chromatography column outlet and passes along the second column effluent fluid flow path and is directed along a second column waste fluid flow path to the waste tank.

After a pre-defined amount of time, corresponding to the time for the target molecule to break through the second chromatography column, the effluent from the second chromatography column is directed from the second column effluent fluid flow path along the second desired component fluid flow path to the inlet of the TFF device (if the optional surge tank is present, fluid can be passed into the tank and subsequently to the inlet of the TFF device).

After the flush procedure for the first chromatography column is completed, a wash procedure is initiated on the first chromatography column. The wash buffer is pumped from the wash buffer tank to the inlet of the first chromatography column. This releases some impurities that are weakly bound on the first chromatography sorbent while the feed solution is applied on the first chromatography column. The target molecule, which is captured during this period, remains bound. The effluent from the outlet of the first chromatography column is still directed along the first column waste fluid flow path to the waste tank during the wash procedure.

After a pre-defined amount of time, an elution procedure is initiated on the first chromatography column. The elution buffer is pumped from the elution buffer tank to the inlet of the first chromatography column. Simultaneously, flow from the outlet of the first chromatography column is directed from the first column effluent fluid flow path along the first column eluted fluid flow path to the product tank to collect the purified target molecule eluted from the first chromatography sorbent.

After a pre-defined amount of time, corresponding to the time required to completely eluted any bound material from the first chromatography column, a cleaning procedure is initiated on the first chromatography column. The cleaning solution is pumped from the cleaning solution tank to the inlet of the first chromatography column. Simultaneously, flow from the outlet of the first chromatography column is directed from the first column effluent fluid flow path along the first column waste fluid flow path to the waste tank.

After a pre-defined amount of time, corresponding to the time required to completely remove any bound material from the first chromatography column, a re-equilibration procedure is initiated on the first chromatography column. The equilibration buffer is pumped from the equilibration buffer tank to the inlet of the first chromatography column. Flow from the outlet of the first chromatography column remains directed along the first column waste fluid flow path to the waste tank during the re-equilibration procedure. Equilibration buffer is delivered to the first chromatography column for a pre-defined amount of time. At this point a first process cycle is completed on the first chromatography column.

After the first process cycle is completed on the first chromatography column, and after a pre-defined amount of time, corresponding to the time at which the desired amount of target molecule is bound onto the second chromatography sorbent within the second chromatography column, the feed solution load on the second chromatography column is stopped. After this is completed, a flush procedure is initiated on the second chromatography column, and feed solution is directed to the inlet of the first chromatography device via the mixing tank (the mixing tank also receiving retentate), and feed solution is loaded onto the first chromatography column.

At this point, a new process cycle starts on the first chromatography column while the second chromatography column is going through the flush, wash, elution, cleaning, and re-equilibration procedures.

With respect to the flush procedure initiated on the second chromatography column, equilibration buffer is pumped from the equilibration buffer tank to the inlet of the second chromatography column, wherein the buffer displaces unbound target molecule and impurities and passes them to the outlet of the second chromatography column and along the second column effluent fluid flow path and the second desired component flow path to the inlet of the TFF device. The flow through the second chromatography column remains unchanged for a pre-defined amount of time (for example, the time required to pump a volume of equilibration buffer equivalent to 1.5 times the volume of the second chromatography column). When that time has elapsed, the effluent from the outlet of the second chromatography column is directed from the second column effluent fluid flow path along the second column waste fluid flow path to the waste tank.

While equilibrium buffer is pumped to the second chromatography column, feed solution, containing target molecule and impurities is directed to the inlet of the first chromatography column via the mixing tank (the vessel also receiving the stream, passed along the desired component recycle fluid flow path, from the retentate from the TFF device), and feed solution is loaded onto the first chromatography device.

The feed solution, containing the target molecule and some impurities, passes into the first chromatography column and contacts the first sorbent, wherein some of the feed solution including the target molecule binds to the first sorbent and most of the other feed solution (i.e., providing the effluent) including impurities and possibly some target, exits the first chromtography column through the first chromatography column outlet and passes along the first column effluent fluid flow path and is directed along the first column waste fluid flow path to the waste tank.

After a pre-defined amount of time, corresponding to the time for the target molecule to break through the first chromatography column, the effluent from the first chromatography column is directed from the first column effluent fluid flow path along the first desired component fluid flow path to the inlet of the TFF device.

After flushing of the second chromatography column has been completed, a wash procedure is initiated on the second chromatography column. The wash buffer is pumped from the wash buffer tank to the inlet of the second chromatography column. This releases some impurities that are weakly bound on the second chromatography sorbent while the feed solution is applied on the second chromatography column. The target molecule, which is captured during this period, remains bound. The effluent from the outlet of the second chromatography column is still directed along the second column waste fluid flow path to the waste tank during the wash procedure.

After a pre-defined amount of time, an elution procedure is initiated on the second chromatography column. The elution buffer is pumped from the elution buffer tank to the inlet of the second chromatography column. Simultaneously, flow from the outlet of the second chromatography column is directed from the second column effluent fluid flow path along the second column eluted fluid flow path to the product tank to collect the purified target molecule eluted from the second chromatography sorbent.

After a pre-defined amount of time, corresponding to the time required to completely eluted any bound material from the second chromatography column, a cleaning procedure is initiated on the second chromatography column. The cleaning solution is pumped from the cleaning solution tank to the inlet of the second chromatography column. Simultaneously, flow from the outlet of the second chromatography column is directed from the second column effluent fluid flow path along the second column waste fluid flow path to the waste tank.

After a pre-defined amount of time, corresponding to the time required to completely remove any bound material from the second chromatography column, a re-equilibration procedure is initiated on the second chromatography column. The equilibration buffer is pumped from the equilibration buffer tank to the inlet of the second chromatography column. Flow from the outlet of the second chromatography column remains directed along the second column waste fluid flow path to the waste tank during the re-equilibration procedure. Equilibration buffer is delivered to the second chromatography column for a pre-defined amount of time. At this point a first process cycle is completed on the second chromatography column.

After the first process cycle is completed on the second chromatography column, and after a pre-defined amount of time, corresponding to the time at which the desired amount of target molecule is bound onto the first chromatography sorbent within the first chromatography column, the feed solution load on the first chromatography column is stopped. After this is completed, a flush procedure is initiated on the first chromatography column, and the retentate from the TFF device (passing along the desired component recycle fluid flow path) is mixed with continuous feed in the mixing tank, and the feed solution is directed to the inlet of the second chromatography device and feed solution is loaded onto the second chromatography column.

At this point, a new process cycle starts on the second chromatography column while the first chromatography column is going through the flush, wash, elution, cleaning, and re-equilibration procedures.

Additional cycles are initiated by repeating cycles as set out above. The feed solution (including retentate from the TFF device) is directed to one chromatography column at a time while the other column (or another column if the system includes more than two chromatography columns) is going through the flush, wash, elution, cleaning, and re-equilibration procedures. The process can continue indefinitely by switching a chromatography column in and out of the feed sample load procedure.

At the end of the process the continuous feed flow is stopped. To maintain the volume of liquid in the system, flow from the first (permeate) outlet of the TFF device along the third waste fluid flow path is stopped and the volume in the system remains close to constant. The process is ended when an acceptable amount of target molecule is bound and eluted from the chromatography columns with minimal amount of target molecule remaining in the system.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited (o,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A continuous chromatography system comprising:
(a) a first chromatography device for capturing at least one desired component, the first chromatography device comprising a housing having an inlet and an outlet and providing a fluid flow path between the inlet and the outlet; and a first chromatography medium disposed in the housing across the fluid flow path;
(b) a tangential flow filtration device, comprising a housing comprising an inlet, a first outlet, and a second outlet, defining a first fluid flow path between the inlet and the first outlet, and a second fluid flow path between the inlet and the second outlet, and a porous filter element comprising at least one porous membrane across the first fluid flow path, wherein the second outlet of the tangential flow filtration device is in fluid communication with the inlet of the first chromatography device, and with an inlet of a second chromatography device for capturing the at least one desired component;
(c) a first effluent fluid flow path in fluid communication with the outlet of the first chromatography device, the first effluent fluid flow path comprising at least a first conduit;
(d)
(di) a first sensor associated with the first effluent fluid flow path, wherein the sensor detects the presence or absence of the desired component passing from the outlet of the first chromatography device along the first effluent fluid flow path, and provides a signal indicating of the presence or absence of the desired component, or
(dii) a time control arrangement, providing a signal indicating a set period of time with respect to operation of the first chromatography device has elapsed;
(e) a first downstream controllable flow control arrangement comprising a first valve, downstream of the outlet of the first chromatography device, and downstream of the first sensor if present, the first downstream controllable flow control arrangement being in fluid communication with the first effluent fluid flow path, wherein,
(ei) after the signal indicating of the presence or absence of the desired component is provided, or
(eii) after the signal indicating the set period of time has elapsed is provided;
the first downstream controllable flow control arrangement allows and/or prevents fluid flow along a first eluted component fluid flow path, a first waste fluid flow path, and a first desired component recycle fluid flow path; wherein the first eluted component fluid flow path, the first waste fluid flow path, and the first desired component recycle fluid flow path are downstream of, and in fluid communication with, the first downstream controllable flow control arrangement;
(f) the first eluted component fluid flow path comprising at least a second conduit;
(g) an eluted component container, downstream of, and in fluid communication with, the first eluted component fluid flow path, and with a second eluted component fluid flow path;
(h) the first waste fluid flow path comprising at least a third conduit;
(i) a waste container, downstream of, and in fluid communication with, the first waste fluid flow path and with a second waste fluid flow path;
(j) the first desired component recycle fluid flow path comprising at least a fourth conduit;
(k) a mixing container, suitable for receiving continuous feed and desired component recycle fluid comprising a desired component to be purified, in fluid communication with the first desired component recycle fluid flow path, and with the inlet of the tangential flow filtration device, and with a second desired component recycle fluid flow path;
(l) the second chromatography device for capturing the at least one desired component, the second chromatography device comprising a housing having the inlet and an outlet and providing a fluid flow path between the inlet and the outlet; and a second chromatography medium disposed in the housing across the fluid flow path;
(m) a second effluent fluid flow path in fluid communication with the outlet of the second chromatography device, the second effluent fluid flow path comprising at least a fifth conduit;
(n)
(ni) a second sensor associated with the second effluent fluid flow path, wherein the sensor detects the presence or absence of the desired component passing from the outlet of the second chromatography device along the second effluent fluid flow path, and provides a signal indicating of the presence or absence of the desired component, or
(nii) a time control arrangement, providing a signal indicating a set period of time with respect to operation of the second chromatography device has elapsed;
(o) a second downstream controllable flow control arrangement comprising a second valve, downstream of the outlet of the second chromatography device, and downstream of the second sensor if present, the second downstream controllable flow control arrangement being in fluid communication with the second effluent fluid flow path, wherein,
(oi) after the signal indicating of the presence or absence of the desired component is provided, or
(oii) after the signal indicating the set period of time has elapsed is provided;
the second downstream controllable flow arrangement allows and/or prevents fluid flow along the second eluted component fluid flow path, the second waste fluid flow path, and the second desired component recycle fluid flow path; wherein the second eluted component fluid flow path, the second waste fluid flow path, and the second desired component recycle fluid flow path are downstream of, and in fluid communication with, the second downstream controllable flow arrangement;
(p) the second eluted component fluid flow path comprising at least a sixth conduit, wherein the eluted component container of (g) is downstream of; and in fluid communication with, both the second eluted component fluid flow path and the first eluted component fluid flow path;
(q) the second waste fluid flow path comprising at least a seventh conduit, wherein the waste container of (i) is downstream of, and in fluid communication with, both the second waste fluid flow path and the first waste fluid flow path; and,
(r) the second desired component recycle fluid flow path comprising at least an eighth conduit, wherein the mixing container of (k) is in fluid communication with the first desired component recycle fluid flow path, and the second desired component recycle fluid flow path, and the inlet of the tangential flow filtration device.

2. A chromatography system comprising;
(a) a first chromatography device for capturing at least one desired component, the first chromatography device comprising a housing having an inlet and an outlet and providing a fluid flow path between the inlet and the outlet; and a first chromatography medium disposed in the housing across the fluid flow path;
(b) a first effluent fluid flow path in fluid communication with the outlet of the first chromatography device, the first effluent fluid flow path comprising at least a first conduit;
(c)
(ci) a first sensor associated with the first effluent fluid flow path, wherein the first sensor detects the presence or absence of the desired component passing from the outlet of the first chromatography device along the first effluent fluid flow path, and provides a signal indicating of the presence or absence of the desired component, or
(cii) a time control arrangement, providing a signal indicating a set period of time with respect to operation of the first chromatography device has elapsed;
(d) a first downstream controllable flow control arrangement comprising a first valve, downstream of the outlet of the first chromatography device, and downstream of the first sensor if present, the first downstream controllable flow control arrangement being in fluid communication with the first effluent fluid flow path, wherein, after the signal indicative of the presence or absence of the desired component is provided, the first downstream controllable flow arrangement allows and/or prevents fluid flow along a first eluted component fluid flow path, a first waste fluid flow path, and a first desired component fluid flow path; wherein the first eluted component fluid flow path, the first waste fluid flow path, and the first desired component fluid flow path are downstream of and in fluid communication with, the first downstream controllable flow arrangement;
(e) the first eluted component fluid flow path comprising at least a second conduit;
(f) an eluted component container, downstream of, and in fluid communication with, the first eluted component fluid flow path and a second eluted component fluid flow path;
(g) the first waste fluid flow path comprising at least a third conduit;
(h) a waste container, downstream of and in fluid communication with, the first waste fluid flow path and a second waste fluid flow path;
(i) the first desired component fluid flow path comprising at least a fourth conduit;
(j) a tangential flow filtration device, comprising a housing comprising an inlet, a first outlet, and a second outlet, defining a first fluid flow path between the inlet and the first outlet, and a second fluid flow path between the inlet and the second outlet, and a porous filter element comprising at least one porous membrane across the first fluid flow path, wherein the inlet of the tangential flow filtration device is in fluid communication with the first desired component fluid flow path and with a second desired component fluid flow path, and the second outlet is in fluid communication with a desired component recycle fluid flow path; and,
(k) a mixing container, suitable for receiving desired component recycle fluid comprising a desired component to be purified, in fluid communication with the second outlet of the tangential flow filtration device, wherein the mixing container is also in fluid communication with the inlet of the first chromatography device, and with an inlet of a second chromatography device, and wherein the mixing container is also suitable for receiving continuous feed comprising the desired component to be purified;
(l) the second chromatography device for capturing the at least one desired component, the second chromatography device comprising a housing having the inlet and an outlet and providing a fluid flow path between the inlet and the outlet; and a second chromatography medium disposed in the housing across the fluid flow path;
(m) a second effluent fluid flow path in fluid communication with the outlet of the second chromatography device, the second effluent fluid flow path comprising at least a fifth conduit;
(n)
(ni) a second sensor associated with the second effluent fluid flow path, wherein the sensor detects the presence or absence of the desired component passing from the outlet of the second chromatography device along the second effluent fluid flow path, and provides a signal indicating of the presence or absence of the desired component, or
(nii) a time control arrangement, providing a signal indicating a set period of time with respect to operation of the second chromatography device has elapsed;
(o) a second downstream controllable flow control arrangement comprising a second valve, downstream of the outlet of the second chromatography device, and downstream of the second sensor if present, the second downstream controllable flow control arrangement being in fluid communication with the second effluent fluid flow path, wherein,
(oi) after the signal indicating of the presence or absence of the desired component is provided, or
(oii) after the signal indicating the set period of time has elapsed is provided;
the second flow control arrangement allows and/or prevents fluid flow along the second eluted component fluid flow path, the second waste fluid flow path, and the second desired component fluid flow path; wherein the second eluted component fluid flow path, the second waste fluid flow path, and the second desired component fluid flow path are downstream of, and in fluid communication with, the second flow control arrangement;
(p) the second eluted component fluid flow path comprising at least a sixth conduit, wherein the eluted component container of (g) is downstream of, and in fluid communication with, both the second eluted component fluid flow path and the first eluted component fluid flow path;
(q) the second waste fluid flow path comprising at least a seventh conduit, wherein the waste container of (h) is downstream of, and in fluid communication with, both the second waste fluid flow path and the first waste fluid flow path; and,
(r) the second desired component fluid flow path comprising at least an eighth conduit, wherein the inlet of the tangential flow filtration device of (j) is in fluid communication with the first desired component fluid flow path, and the second desired component fluid flow path.

3. The chromatography system of claim 1, further comprising a first upstream controllable flow control arrangement comprising a third valve, upstream of, and in fluid communication with, the inlet of the first chromatography device, and a second upstream controllable flow control arrangement comprising a fourth valve, upstream of, and in fluid communication with, the inlet of the second chromatography device.

4. The chromatography system of claim 3, wherein the first and second upstream controllable flow control arrangements are in fluid communication with the second outlet of the tangential fluid filtration device.

5. The chromatography system of claim 3, wherein the first and second upstream controllable flow control arrangements are in fluid communication with the mixing container.

6. The chromatography system of claim 1, further comprising a third waste fluid flow path, comprising an additional conduit, in fluid communication with the first outlet of the tangential flow filtration device and the waste container.

7. The chromatography system of claim 1, wherein the first and second chromatography devices each comprise a chromatography column.

8. The chromatography system of claim 1, wherein the first and second chromatography devices each comprise a chromatography monolith.

9. The chromatography system of claim 1, wherein the first and second chromatography devices each comprise a chromatography capsule or a chromatography cartridge.

10. The chromatography system of claim 1, wherein the first sensor and the second sensor each detect the presence of the desired component compared to a pre-set value.

11. A chromatographic method for obtaining at least one desired component, the method comprising:
(a) passing a fluid comprising at least one desired component from a mixing container and into a tangential flow filtration device, the tangential flow filtration device comprising a housing comprising an inlet, a first outlet, and a second outlet, defining a first fluid flow path between the inlet and the first outlet, and a second fluid flow path between the inlet and the second outlet, and a porous filter element having an upstream surface and a downstream surface and comprising a porous membrane across the first fluid flow path, wherein the second outlet of the tangential flow filtration device is in fluid communication with an inlet of a first chromatography device; passing the fluid comprising at least one desired component tangentially to the upstream surface of the filter element; passing a desired component concentrated fluid tangentially to the upstream surface and along the second fluid flow path and through the second outlet into the inlet of the chromatography device; and passing a desired component reduced fluid along the first fluid flow path through the filter element and through the first outlet along a third waste fluid flow path to a waste container;
(b) passing the desired component concentrated fluid into the first chromatography device, the first chromatography device comprising a housing having the inlet and an outlet and providing a fluid flow path between the inlet and the outlet; and a first chromatography medium for binding the at least one desired component, disposed in the housing across the fluid flow path;
(c) passing fluid from the outlet of the first chromatography device along a first effluent fluid flow path, including
(ci) detecting the presence or absence of the desired component(s) in the fluid, or
(cii) determining whether one or more set periods of time have elapsed, the set periods of time comprising a first waste fluid flow time, a first desired component recycle fluid flow time, and a first eluted component fluid flow path time;
(d) opening and/or closing one or more of the following flow paths: a first desired component recycle fluid flow path, a first waste fluid flow path, and a first eluted component fluid flow path, wherein,
(di) if the desired component(s) is not detected, or detected at less than a preset value, or
(dii) if the first desired component recycle fluid flow time has not elapsed, the first desired component recycle fluid flow path is opened, and the first waste fluid flow path and the first eluted component fluid flow path are closed; and,
(diii) if the desired component(s) is detected at equal to, or greater than, the pre-set value, or
(div) if the first desired component recycle fluid flow time has not elapsed, the first desired component recycle fluid flow path is opened or remains open, and the first waste fluid flow path and the first eluted component fluid flow path are closed or remain closed; and,
(dv) if after the desired component(s) have previously been detected at equal to, or greater than, the pre-set value, and the desired component(s) is subsequently not detected, or detected at less than the pre-set value, or
(dvi) if the first desired component recycle fluid flow time has elapsed, the first desired component recycle fluid flow path and the first eluted component fluid flow path are closed, and the first waste fluid flow path is opened;
(e) passing fluid along the opened fluid flow path, wherein, if the first waste fluid flow path is opened, the method includes passing fluid along the first waste fluid flow path into a waste container, and if the first desired component recycle fluid flow path is opened, the method includes passing fluid along the first desired component recycle fluid flow path into the mixing container, and passing fluid from the mixing container into the inlet of the tangential fluid flow filter device;
(f) passing the desired component concentrated fluid from the second outlet of the tangential flow filtration device into a second chromatography device, the second chromatography device comprising a housing having the inlet and an outlet and providing a fluid flow path between the inlet and the outlet; and a second chromatography medium for binding the at least one desired component, disposed in the housing across the fluid flow path;
(g) passing fluid from the outlet of the second chromatography device along a second effluent fluid flow path, including
(gi) detecting the presence or absence of the desired component(s) in the fluid, or
(gii) determining whether one or more set periods of time have elapsed, the set periods of time comprising a second waste fluid flow time, a second desired component recycle fluid flow time, and a second eluted component fluid flow path time;
(h) opening and/or closing one or more of the following flow paths: a second desired component recycle fluid flow path, a second waste fluid flow path, and a second eluted component fluid flow path, wherein,
(hi) if the desired component(s) is not detected, or detected at less than a pre-set value, or
(hii) if the second desired component recycle fluid flow time has not elapsed, the second desired component recycle fluid flow path is opened, and the second waste fluid flow path and the second eluted component fluid flow path are closed; and,
(hiii) if the desired component(s) is detected at equal to, or greater than, the pre-set value, or
(hiv) if the second desired component recycle fluid flow time has not elapsed, the second desired component recycle fluid flow path is opened or remains open, and the second waste fluid flow path and the second eluted component fluid flow path are closed or remain closed; and,
(hv) if after the desired component(s) have previously been detected at equal to, or greater than, the pre-set value, and the desired component(s) is subsequently not detected, or detected at less than the pre-set value, or
(hvi) if the second desired component recycle fluid flow time has elapsed,
the second desired component recycle fluid flow path and the second eluted component fluid flow path are closed, and the second waste fluid flow path is opened;
(i) passing fluid along the opened fluid flow path, wherein, if the second waste fluid flow path is opened, the method includes passing fluid along the second waste fluid flow path into the waste container, and if the second desired component recycle fluid flow path is opened, the method includes passing fluid along the second desired component recycle fluid flow path into the mixing container, and passing fluid from the mixing container into the tangential fluid flow filter device; and
(j) repeating (a)-(i) at least once.

12. A chromatographic method for obtaining at least one desired component, the method comprising:
(a) passing a fluid comprising at least one desired component from a mixing container and into an inlet of a first chromatography device, and through the first chromatography device, the device comprising a housing having the inlet and an outlet and providing a fluid flow path between the inlet and the outlet; and a first chromatography medium for binding the at least one desired component, disposed in the housing across the fluid flow path;
(b) passing fluid from the outlet of the first chromatography device along a first effluent fluid flow path, including
(bi) detecting the presence or absence of the desired component(s) in the fluid, or
(bii) determining whether one or more set periods of time have elapsed, the set periods of time comprising a first waste fluid flow time, a first desired component fluid flow time, and a first eluted component fluid flow path time;
(c) opening and/or closing one or more of the following flow paths: a first desired component fluid flow path, a first waste fluid flow path, and a first eluted component fluid flow path, wherein,
(ci) if the desired component(s) is not detected, or detected at less than a pre-set value, or
(cii) if the desired component fluid flow time has not elapsed, the first desired component fluid flow path is opened, and the first waste fluid flow path and the first eluted component fluid flow path are closed; and,
(ciii) if the desired component(s) is detected at equal to, or greater than, the pre-set value, or
(civ) if the first desired component fluid flow time has not elapsed,
the first desired component fluid flow path is opened or remains open, and the first waste fluid flow path and the first eluted component fluid flow path are closed or remain closed; and,
(cv) if after the desired component(s) have previously been detected at equal to, or greater than, the pre-set value, and the desired component(s) is subsequently not detected, or detected at less than the pre-set value, or
(cvi) if the first desired component fluid flow time has elapsed, the first desired component fluid flow path and the first eluted component fluid flow path are closed, and the first waste fluid flow path is opened;
(d) passing fluid along the opened fluid flow path, wherein, if the first waste fluid flow path is opened, the method includes passing fluid along the first waste fluid flow path into a waste container, and if the first desired component fluid flow path is opened, the method includes passing fluid along the first desired component fluid flow path into an inlet of a tangential fluid flow filter device, the tangential flow filtration device comprising a housing comprising the inlet, a first outlet, and a second outlet, defining a first fluid flow path between the inlet and the first outlet, and a second fluid flow path between the inlet and the second outlet, and a porous filter element having an upstream surface and a downstream surface and comprising a porous membrane across the first fluid flow path, wherein the second outlet of the tangential flow filtration device is in fluid communication with the mixing container via a desired component recycle fluid flow path, wherein the mixing container is also in fluid communication with both the second outlet of the tangential flow filtration device and the inlet of the first chromatography device, and wherein the mixing container also receives fluid along a continuous feed;
(e) passing the fluid comprising at least one desired component tangentially to the upstream surface of the filter element; passing a desired component concentrated fluid tangentially to the upstream surface and along the second fluid flow path and through the second outlet along the desired component recycle fluid path into the mixing container; and passing a desired component reduced fluid along the first fluid flow path through the filter element and through the first outlet along a third waste fluid flow path to a waste container;
(f) passing fluid from the mixing container into a second chromatography device, the second chromatography device comprising a housing having the inlet and an outlet and providing a fluid flow path between the inlet and the outlet; and a second chromatography medium for binding the at least one desired component, disposed in the housing across the fluid flow path;
(g) passing fluid from the outlet of the second chromatography device along a second effluent fluid flow path, including
(gi) detecting the presence or absence of the desired component(s) in the fluid, or
(gii) determining whether one or more set periods of time have elapsed, the set periods of time comprising a second waste fluid flow time, a second desired component fluid flow time, and a second eluted component fluid flow path time;
(h) opening and/or closing one or more of the following flow paths: a second desired component fluid flow path, a second waste fluid flow path, and a second eluted component fluid flow path, wherein,
(hi) if the desired component(s) is not detected, or detected at less than a pre-set value, or
(hii) if the second desired component fluid flow time has not elapsed, the second desired component fluid flow path is opened, and the second waste fluid flow path and the second eluted component fluid flow path are closed; and,
(hiii) if the desired component(s) is detected at equal to, or greater than, the pre-set value, or
(hiv) if the second desired component fluid flow time has not elapsed,
the second desired component fluid flow path is opened or remains open, and the second waste fluid flow path and the second eluted component fluid flow path are dosed or remain closed; and,
(hv) if after the desired component(s) have previously been detected at equal to, or greater than, the pre-set value, and the desired component(s) is subsequently not detected, or detected at less than the pre-set value, or
(hvi) if the second desired component fluid flow time has elapsed,
the second desired component fluid flow path and the second eluted component fluid flow path are closed, and the second waste fluid flow path is opened;
(i) passing fluid along the opened fluid flow path, wherein, if the second waste fluid flow path is opened, the method includes passing fluid along the second waste fluid flow path into the waste container, and if the second desired component fluid flow path is opened, the method includes passing fluid along the second desired component fluid flow path into the inlet of the tangential fluid flow filter device; and
(j) repeating (a)-(i) at least once.

13. The method of claim 11, further comprising:
(k) closing the first desired component recycle fluid flow path or the first desired component fluid flow path, and the first waste fluid flow path, and opening the first eluted component fluid flow path; and;
(l) passing an elution fluid through the first chromatography device, and passing desired component(s) containing elution fluid from the outlet of the first chromatograph device along the first eluted component fluid flow path into the eluted component container.

14. The method of claim 11, further comprising:
(m) closing the second desired component recycle fluid flow path or the second desired component fluid flow path, and the second waste fluid flow path, and opening the second eluted component fluid flow path; and;
(n) passing an elution fluid through the second chromatography device, and passing desired component(s) containing elution fluid from the outlet of the second chromatograph device along the second eluted component fluid flow path into the eluted component container.

15. The method of claim 11, comprising passing fluid through the first chromatography device and the second chromatography device in parallel.

16. The method of claim 11, comprising loading one chromatography device with a fluid containing a desired component to be purified while passing a fluid lacking the desired component to be purified through the other chromatography device.

17. The chromatography system of claim 2, further comprising a first upstream controllable flow control arrangement comprising a third valve, upstream of, and in fluid communication with, the inlet of the first chromatography device, and a second upstream controllable flow control arrangement comprising a fourth valve, upstream of, and in fluid communication with, the inlet of the second chromatography device.

18. The chromatography system of claim 17, wherein the first and second upstream controllable flow control arrangements are in fluid communication with the second outlet of the tangential fluid filtration device.

19. The chromatography system of claim 17, wherein the first and second upstream controllable flow control arrangements are in fluid communication with the mixing container.

20. The chromatography system of claim 2, wherein the first and second chromatography devices each comprise a chromatography column.
